(19) United States
(12) Patent Application Publication
(10) Pub. No.: US 2025/0337650 A1
(43) Pub. Date: Oct. 30, 2025

(54) METHOD AND DEVICE FOR IDENTIFYING RESOURCE FOR NETWORK SLICE

(71) Applicant: Samsung Electronics Co., Ltd., Suwon-si (KR)

(72) Inventor: Seunghoon PARK, Suwon-si (KR)

(21) Appl. No.: 19/259,666

(22) Filed: Jul. 3, 2025

Related U.S. Application Data
(63) Continuation of application No. PCT/KR2023/018496, filed on Nov. 16, 2023.

(30) Foreign Application Priority Data
Jan. 3, 2023 (KR) 10-2023-0000787
Jan. 30, 2023 (KR) 10-2023-0012181

(51) Int. Cl. H04L 41/0894; H04W 48/18

(52) U.S. Cl. CPC H04L 41/0894; H04W 48/18

(57) ABSTRACT

A method performed by means of a first entity is provided. The method includes an operation of receiving, from a second entity for managing a network slice, an initiate message including network slice information, based on the network slice information, transmitting, to a first node of a first domain, a request message including an identifier for indicating a tag, an ingress identifier, an egress identifier, and information about a policy related to the tag, and receiving, from the first node, a response message corresponding to the request message, wherein the ingress identifier includes an identifier indicating a second domain for transmitting a packet to the first domain, wherein the egress identifier includes an identifier indicating a third domain for receiving the packet from the first domain, and wherein the tag is an identifier for mapping an in-domain resource for the packet and at least one network slice associated to the packet.

### CROSS-REFERENCE TO RELATED APPLICATION(S)

This application is a continuation application, claiming priority under 35 U.S.C. § 365 (c), of an International application No. PCT/KR2023/018496, filed on Nov. 16, 2023, which is based on and claims the benefit of a Korean patent application number 10-2023-0000787, filed on Jan. 3, 2023, in the Korean Intellectual Property Office, and of a Korean patent application number 10-2023-0012181, filed on Jan. 30, 2023, in the Korean Intellectual Property Office, the disclosure of each of which is incorporated by reference herein in its entirety.

### BACKGROUND

### 1. Field

The disclosure relates to a method and an apparatus for identifying a resource for a network slice.

### 2. Description of Related Art

With the development of various information technology (IT) technologies, network equipment may be virtualized. For example, a physical network may be implemented as a virtualized network function (NF) (hereinafter, may be referred to as network element). The virtualized NF may be implemented in a form of software beyond physical constraints and may be installed/operated in various types of clouds or data centers (DC). The NF may be freely scaled up/down or initiated/terminated according to service requirements, system capacity, or network load. Even if the NF is implemented in the form of software, it should basically be operated through a physical configuration, and thus the physical configuration may not be excluded. In addition, the NF may be implemented only with hardware.

In a virtualized network architecture, a network slicing technology has been introduced to support various services. The network slicing may indicate a set of network functions (NFs) for supporting a specific service. The network slicing is a technology that logically configures a virtualized network and separates it into network slices. One terminal may access two or more slices in a case of receiving various services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for identifying a resource for a network slice.

Additional aspects will be set forth in part in the description which follows and, in part, will be apparent from the description, or may be learned by practice of the presented embodiments.

In accordance with an aspect of the disclosure, A method performed by a first entity is provided. The method includes receiving, from a second entity for managing a network slice, an initiate message including network slice information, based on the network slice information, transmitting, to a first node of a first domain, a request message including an identifier for indicating a tag, an ingress identifier, an egress identifier, and information on a policy associated with the tag, and receiving, from the first node, a response message corresponding to the request message, wherein the ingress identifier includes an identifier indicating a second domain for transmitting a packet to the first domain, wherein the egress identifier includes an identifier indicating a third domain for receiving the packet from the first domain, and wherein the tag is an identifier for mapping an in-domain resource for the packet and at least one network slice associated with the packet.

In accordance with an aspect of the disclosure, a first entity is provided. The first entity includes memory, including one or more storage media, storing instructions, a transceiver, and at least one processor communicatively coupled to the transceiver and the memory, wherein the instructions, when executed by the at least one processor individually or collectively, cause the first entity to receive, from a second entity for managing a network slice, an initiate message including network slice information, transmit, to a first node of a first domain, a request message including an identifier for indicating a tag, an ingress identifier, an egress identifier, and information on a policy associated with the tag, based on the network slice information, receive, from the first node, a response message corresponding to the request message, wherein the ingress identifier includes an identifier indicating a second domain for transmitting a packet to the first domain, wherein the egress identifier includes an identifier indicating a third domain for receiving the packet from the first domain, and wherein the tag is an identifier for mapping an in-domain resource for the packet and at least one network slice associated with the packet.

In accordance with an aspect of the disclosure, one or more non-transitory computer-readable storage media storing one or more computer programs including computer-executable instructions that, when executed by at least one processor of a first entity including a transceiver individually or collectively, cause the first entity to perform operations are provided. The operations include receiving, from a second entity for managing a network slice, an initiate message including network slice information, transmitting, to a first node of a first domain, a request message including an identifier for indicating a tag, an ingress identifier, an egress identifier, and information on a policy associated with the tag, based on the network slice information, and receiving, from the first node, a response message corresponding to the request message, wherein the ingress identifier includes an identifier indicating a second domain for transmitting a packet to the first domain, wherein the egress identifier includes an identifier indicating a third domain for receiving the packet from the first domain, and wherein the tag is an identifier for mapping an in-domain resource for the packet and at least one network slice associated with the packet.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates an example of an end-to-end (E2E) network slicing architecture according to an embodiment of the disclosure;

FIG. 1B illustrates an example of a management plane of an end-to-end (E2E) network slicing architecture according to an embodiment of the disclosure;

FIG. 2 illustrates an example of a factor for identifying a service requirement according to an embodiment of the disclosure;

FIGS. 3A and 3B illustrate examples of domain-specific resource division for a network slice according to various embodiments of the disclosure;

FIG. 4 illustrates an example of mapping between a resource and a tag for a network slice according to an embodiment of the disclosure;

FIG. 5 illustrates an example of mapping between a function and a tag for a network slice according to an embodiment of the disclosure;

FIG. 6 illustrates an example of a logical connection relationship according to tag mapping for a plurality of domains according to an embodiment of the disclosure;

FIG. 7 illustrates an example of an operation of a mapper for setting a tag according to an embodiment of the disclosure;

FIG. 8 illustrates an example of a method of mapping a tag to a resource or a policy according to an embodiment of the disclosure;

FIG. 9 illustrates an example of a tag mapping method in a DU according to an embodiment of the disclosure;

FIG. 10 illustrates an example of a tag mapping method in a CU according to an embodiment of the disclosure;

FIG. 11 illustrates another example of a tag mapping method in a CU according to an embodiment of the disclosure;

FIG. 12 illustrates an example of a tag mapping method in a CN according to an embodiment of the disclosure;

FIG. 13 illustrates an example in which a tag policy manager manages tag mapping for a plurality of domains according to an embodiment of the disclosure;

FIG. 14 illustrates an example of an operation flow in which a tag policy manager manages tag mapping according to an embodiment of the disclosure;

FIG. 15 is a flowchart illustrating an example of a method in which a tag policy manager manages tag mapping according to an embodiment of the disclosure;

FIG. 16 illustrates examples of a mapping relationship between a service and a resource or function according to an embodiment of the disclosure;

FIG. 17 illustrates examples of a network slice management structure according to an embodiment of the disclosure;

FIG. 18 illustrates examples of a network slice management structure based on a plurality of tags according to an embodiment of the disclosure;

FIG. 19 illustrates examples of an intent-based network slice management structure according to an embodiment of the disclosure; and

FIG. 20 illustrates an example of a configuration of a device in a wireless communication system according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictate otherwise. Thus, for example, reference to “a component surface” includes reference to one or more of such surfaces.

In various embodiments of the disclosure described below, a hardware approach will be described as an example. However, since the various embodiments of the disclosure include technology that uses both hardware and software, the various embodiments of the disclosure do not exclude a software-based approach.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’.

Hereinafter, the disclosure relates to a method and a device for supporting various services in a wireless communication system. Specifically, the disclosure proposes a resource provision method and a device that satisfy requirements of a plurality of network slices with as few resource divisions as possible in providing resources for each network slice that requires different characteristics.

Terms referring to a network or a network component (e.g., connection node, node, network entity, entity, domain, or network function (NF)), terms referring to information (e.g., signal, packet, data, message, and the like), terms referring to an interface between network objects, and the like, which are used in the following description are exemplified for convenience of explanation. Therefore, the disclosure is not limited to the terms described below, and other terms referring to subjects having equivalent technical meanings may be used.

For the convenience of the following description, the disclosure uses terms and names defined in 3rd generation partnership project long term evolution (third generation partnership project (3GPP) long term evolution (LTE)) and fifth generation (5G) standards. However, in the disclosure, the terms and names are not limited, and the same may be applied to systems according to other standards.

Hereinafter, for convenience of description, objects for processing and exchanging information for access control, packet transmission, and state management may be referred to as a network function (NF) device. In addition, the NF device may be referred to as an NF for convenience of description. The NF may be defined through a standard or may be implemented as a non-standard. For example, the NF device may include at least one entity/device among a scheduler entity allocating physical resources at a base station device, a packet data convergence protocol (PDCP) entity responsible for packet flow control at a base station, a service data adaptation protocol (SDAP) entity responsible for quality of service (QOS) control at a base station, a user plane function (UPF) device responsible for packet transmission in a core network (CN), a policy control function (PCF) device responsible for policy management in the CN, an access and mobility management function (AMF) device, a session management function (SMF) device, and a network slice selection function (NSSF) device. However, embodiments of the disclosure may be equally applied even when the NF is implemented as a virtualization instance.

In the instance, a specific NF may be included in a physical computing system in the form of a code of software. For example, the instance may mean a state in which physical or/or logical resources are allocated from a computing system to perform a function of NF on a specific computing system on a network and are executable. Each of PDCP instance, SDAP instance, UPF instance, and PCF instance may mean a state in which physical or/and logical resources may be allocated and used for PDCP, SDAP, UPF, and PCF operations from a specific computing system existing on a core network. In a case that physical PDCP, SDAP, UPF, and PCF devices exist, PDCP instances, SDAP instances, UPF instances, and PCF instances in which physical or/and logical resources are allocated and used for PDCP, SDAP, UPF, and PCF operations from a specific computing system existing on a network may perform the same operation.

An NF or NF device described below may be implemented as software. For example, a specific function of the NF may be configured to be one NF and/or one NF instance by configuring a specific function of the NF as software and installing the function in a specific computing system on a network. In other words, one NF may be included in a specific computing system on the network. As another example, one NF may be included in two or more computing systems on the network. In addition, one computing system on the network may include one NF instance or two or more NF instances. In this case, the NF instance may be NF instances performing the same function or NF instances performing different functions. Therefore, in an embodiment of this disclosure, NF (Scheduler, PDCP, SDAP, UPF, PCF, and the like) may be replaced by NF instance, or conversely, matters described as the NF instance may be replaced with NF. In an embodiment of the disclosure, matters described as a network slice may be replaced by a network slice instance, or conversely, matters described as a network slice instance may be replaced by a network slice.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

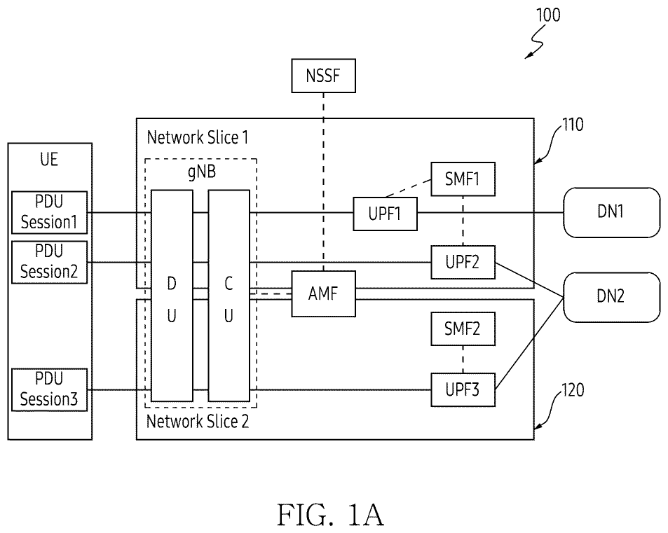

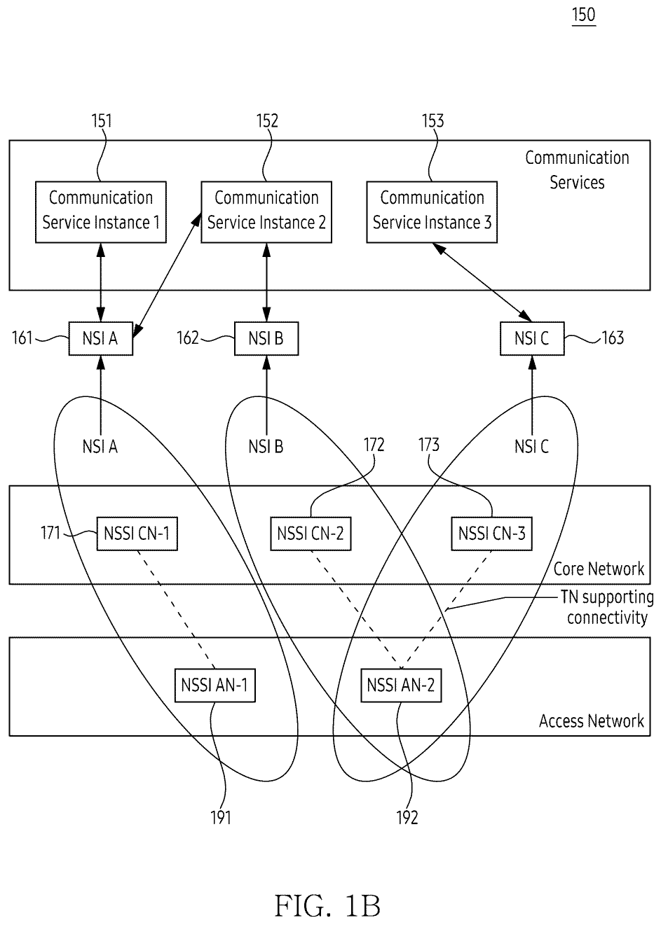

FIG. 1A illustrates an example of an end-to-end (E2E) network slicing architecture according to an embodiment of the disclosure.

The network slicing is a technology for supporting a plurality of services having different service characteristics or service requirements as one physical network. A network slice (or slice) may indicate each configuration separated by virtualizing physical network resources to satisfy service requirements. An operator may configure resources for a slice corresponding to a characteristic of a slice identifier defined in the 3GPP standard. The slice identifier may include Network Slice Selection Assistance Information (NSSAI).

FIG. 1A illustrates an example 100 of a network in which a first slice 110 and a second slice 120 are formed. The network may include a first data network (DN), a second DN, a first user plane function (UPF), a second UPF, a third UPF, a first session management function (SMF), a second SMF, an access and mobility management function (AMF), a 5G base station (5G gNB, a gNB) (or a base station), a user equipment (UE), and a network slice selection function (NSSF).

When receiving a session connection request from a user equipment (UE) for a specific slice identifier, a network management device (not shown) may instruct to generate the session with network resources supporting the characteristics of the slice identifier through a session setting process. In an example, the first SMF (or the second SMF) may transmit slice identifiers and session information to the AMF and the 5G base station in a process of setting up a session. The first SMF (or the second SMF) may set up a session with a radio access network (RAN) resource and a core network (CN) resource supporting the slice identifier indicated by the network management device. The slice identifier may include an identifier for the first slice 110 and the second slice 120.

The 5G base station may be logically divided into a distributed unit (DU) and a centralized unit (CU). The DU may include a physical layer and a medium access control (MAC) layer. The CU may include a radio link control (RLC) layer, a PDCP layer, and an SDAP. With respect to the terminal, the first slice 110 (or the second slice 120) may be provided as a protocol data unit (PDU) session. For example, the first slice 110 may be provided through a first PDU session and a second PDU session. The PDU session may set a terminal and a DN as both ends of an Internet protocol (IP). A base station (or RAN device) including the DU and the CU and the AMF may be shared regardless of the network slice in terms of wireless access and mobility management of the terminal. In an example, the first slice 110 and the second slice 120 may be configured by sharing the AMF with the base station. The example 100 illustrates that the first slice 110 and the second slice 120 are set in common with the base station, but the base station may separately process and transmit packets for the PDU session for the first slice 110 and the second slice 120.

Referring to the example 100, the UPF may serve as a gateway for packet transmission and reception to DN outside a business network and perform IP session management within the business network. For example, a first UPF may transmit and receive packets for the first DN, perform IP session management for the first DN, and the second UPF and the third UPF may transmit and receive packets for the second DN, and perform IP session management for the second DN. The UPF may be allocated for each slice and may operate according to a capacity and a QoS policy corresponding to a service requirement. For example, the first UPF and the second UPF may be allocated with respect to the first slice 110. The third UPF may be allocated with respect to the second slice 120.

The SMF may be configured in common regardless of slices, or may be configured for each slice. The example 100 illustrates that the first slice 110 is set for the first SMF and the second slice 120 is set for the second SMF, but the first slice 110 and the second slice 120 may be set for one SMF.

The NSSF may inform a slice format that may be provided by a network by receiving a request from the AMF. Referring to the example 100, the NSSF may transmit information on the first slice 110 and the second slice 120 to the AMF, in response to the request from the AMF.

The NSSAI corresponding to each of the first slice 110 and the second slice 120 may be composed of one or more single NSSAI (S-NSSAI). The S-NSSAI may include a slice/service type (SST) and a slice differentiator (SD). The AMF may identify whether the NSSAI requested in a procedure of registering the terminal in a specific public land mobile network (PLMN) corresponds to a slice (subscribed NSSAI) to which the terminal is subscribed. The NSSF may, for example, identify an AMF capable of providing a slice corresponding to a tracking area TA associated with the terminal. The NSSF may identify an AMF suitable for the terminal and transmit the suitable NSSAI to the terminal as the Allowed NSSAI. When registration in the network is completed, the specific PLMN may be converted into a Serving PLMN, and the terminal may store the received Allowed NSSAI for the Serving PLMN.

In the RRC Connection Establishment procedure, the terminal may load a desired slice into the requested S-NSSAI and transmit it to a base station (or RAN). The base station (e.g., CU-control plane (CU-CP)) that processes an RRC message may select the AMF based on stored Configured NSSAI information and transmit a PDU Session Establishment message to the selected AMF. The selected AMF may select SMF according to the Requested S-NSSAI, and may perform a PDU session generation procedure with the selected SMF. The UPF selected through the PDU session generation procedure may be configured at both ends of the IP with respect to the PDU session set based on the procedure together with the terminal. In this case, resources between the terminal and the base station (or SDAP layer of the base station) may be managed by a data radio bearer (DRB), and QoS between the base station (or SDAP layer of the base station) and the UPF may be managed by a QoS flow. The SDAP may map an identity (ID) of the QoS flow and an ID of the DRB.

The terminal may identify a slice according to a UE route selection policy (URSP), based on application-related information (e.g., App ID, data network name (DNN)) including Allowed NSSAI with respect to one or more PDU sessions. The terminal may perform routing for transmitting a packet coming down through an application layer to a PDU session path corresponding to the slice.

FIG. 1B illustrates an example of a management domain of an end-to-end (E2E) network slicing architecture according to an embodiment of the disclosure.

Referring to FIG. 1B, an example 150 illustrates an E2E network slicing architecture in terms of a management plane. For the efficiency of network slice management, an instance of the slice may include a communication service instance (CSI) and a network slice instance (NSI). The CSI may indicate a customer service instance, and the NSI may indicate a network resource instance that maps with the CSI.

Referring to the example 150, communication services may include a plurality of CSIs. For example, communication services may include a first CSI 151, a second CSI 152, and a third CSI 153. In example 150, NSI may be mapped with one or more CSI. For example, NSI A 161 may be mapped with the first CSI 151 and the second CSI 152. NSI B 162 may be mapped with the second CSI 152. The NSI C 163 may be mapped with the third CSI 153. The NSI indicates a slice instance across an end-to-end (E2E) network, and one NSI may be configured by mapping with one or more network slice subnet instance (NSSI). The NSSI may be, for example, a slice instance defined in one management domain. NSSI defined in an RAN domain may be referred to as a NSSI random access network (RAN) (or NSSI AN), NSSI defined in a CN domain may be referred to as NSSI CN, and NSSI defined in a transport network (TN) domain may be referred to as NSSI TN.

For example, one NSSI AN and one or more NSSI CN may be mapped. For example, NSSI AN-1 191 may be mapped to NSSI CN-1 171. NSSI AN-2 192 may be mapped to NSSI CN-2 172 and NSSI CN-3 173. Referring to the example 150, resources of a network (e.g., CN, AN) may be provided through NSI and NSSI with respect to CSI corresponding to a customer's slice (or service) requirement.

In order to configure NSSI with a specific service characteristic, RAN, TN, and CN is required to allocate NSSI and resources for each domain to satisfy the service characteristic in terms of E2E. When building communication equipment on site, the process of capacity analysis, design, installation, and operation may take considerable time and cost. In a case of general public mobile communication networks, operators may identify popular services and service requirements, and may design networks by predicting usage based on the identified services and service requirements. In addition, operators may secure a margin of network resources in consideration of the time of high usage.

In a case of a situation in which network slices should be dynamically provided according to an increase in various services, a network design/equipment method of separately constructing communication equipment according to each service may not be suitable. In a case that resources are divided and resource margin is secured for each slice having different service characteristics, the resources may not be used efficiently. In a case that resources are shared between slices in order to increase resource usage efficiency, it may be difficult to maintain performance that satisfies characteristics for each slice. In an example, in the RAN domain, it may be difficult to dynamically separate and operate individual resources for many slices because the capacity of individual base station devices is limited or a non-virtualization environment is present. On the other hand, in the CN domain, it may be easy to distribute and operate NFs for different slices.

The NSI may include one or more NSSIs. The NSSI mapped to a real resource may be the lowermost NSSI in a hierarchical NSSI structure. In a step in which NSI is contracted for CSI, one or more NSSIs already configured with the CSI and the representative instance of NSI cannot be changed on the management domain. Therefore, it is difficult to change the characteristics of NSSI and NSI once mapped to real resources during operation under the current 3GPP standard.

The network slice information to which a packet belongs may include at least one of an identifier of a network slice or a portion of a network identifier, or a value mapped by the network slice identifier. For example, it may include at least one of the following values.
Total S-NSSAI values
Slice/service type (SST)
Slice differentiator (SD)
Mapped value

Referring to the above description, in order to overcome the difficulty of providing dynamic slices in the network slice structure, the following solution may be considered.

1) A method of dynamically increasing or decreasing the capacity of resources allocated to a slice (scale-up/down)

2) A method of fixing the capacity of resources allocated to a slice and increasing or decreasing the number of resources (scale-in/out)

3) A method of fixing the capacity of resources allocated to a slice and dynamically changing and using different resources by application layers

In the above 1), it is not necessary to change networking of resources in the slice, but the procedure of increasing or decreasing the capacity by monitoring the change in demand of the application layer to dynamically change the capacity of the resource may be complicated and the load may increase. In the above 2), since the capacity of the resource is fixed, the system load is small, but networking should be dynamically reconfigured as the resource is newly generated/deleted, and complexity for optimizing the capacity of the link may be required. In the above 3), since the capacity of resources is fixed and the network link is fixed, the load and complexity of the system may be minimized. However, in order for the application layer to directly monitor performance and comply with service requirements, a function of changing to a resource with different characteristics needs to be provided.

Hereinafter, the disclosure proposes a management method based on a method used by the application layer by dividing resources into parts with different characteristics and dynamically converting them, in consideration of the directionality of the above 3). The device and method according to embodiments of the disclosure consider a method of directly complying at the infrastructure/platform level of the network, based on the target service requirement to reduce the burden on the application layer. The disclosure may support resources of each domain to satisfy various slice requirements in a multi-domain environment.

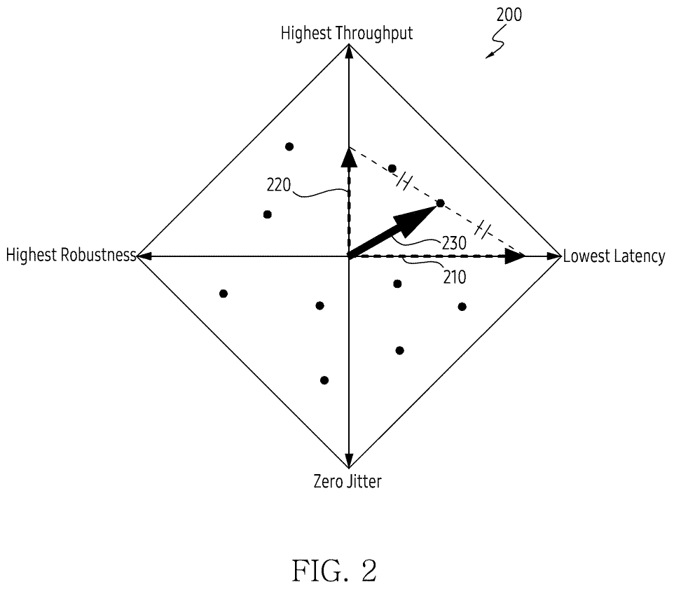

FIG. 2 illustrates an example of a factor for identifying a service requirement according to an embodiment of the disclosure.

FIG. 2 illustrates a method of adjusting a service requirement to be satisfied using a resource corresponding to resource characteristics. Referring to the example 200, the resource characteristics may include throughput, robustness, delay, and jitter.

Referring to an example 200, a first resource 210 may be configured to have a 10 Mbps and a 5 ms delay for a minimum delay. The first resource 210 may be referred to as a minimum delay resource. A second resource 220 may be configured to have a 100 Mbps and a 50 ms delay for high throughput. The second resource 220 may be referred to as a highest transmission resource. A new service 230 may require 30 Mbps and a 20 ms delay. An entity controlling a network may appropriately change and operate the first resource 210 and the second resource 220 for the new service 230. The entity may identify the performance of a service provided through the second resource 220 and then switch to the first resource 210 when the average delay reaches 15 ms to secure a delay margin. When a transmission rate is to be less than 30 Mbps while operating to provide the service using the first resource 210, the entity may switch back to the second resource 220 to provide the service.

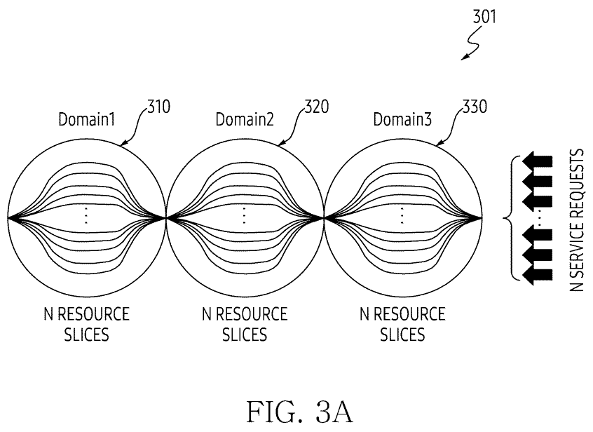

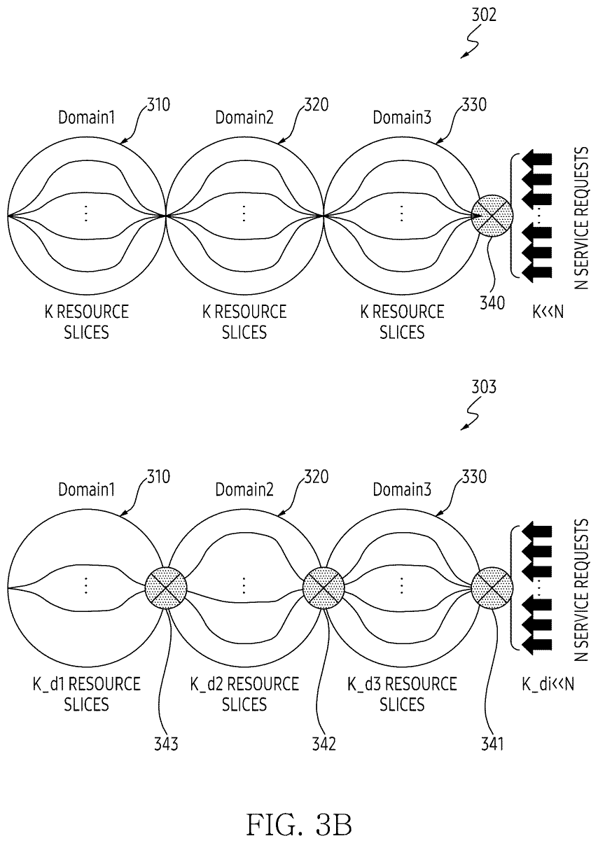

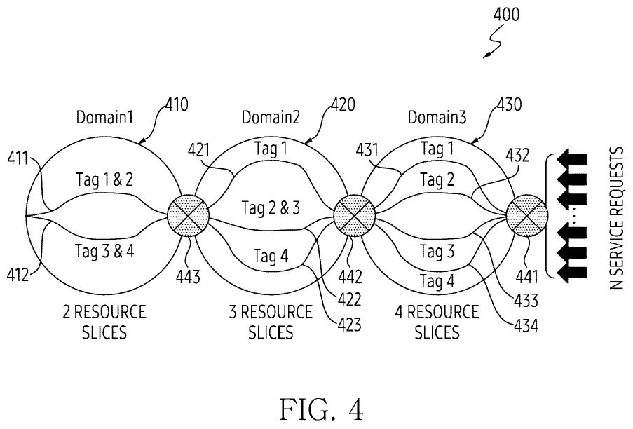

In the disclosure below, for example, when N customer slices (or services) are requested, a method is proposed to support the service by dividing resources in each domain into fewer than N parts, combining them, and dynamically switching the resources according to the service provision performance. A method of dynamically allocating the number of services and resources for each domain in a multi-domain will be described in detail with reference to FIGS. 3A, 3B, and 4.

FIGS. 3A and 3B illustrate examples of domain-specific resource division for a network slice according to various embodiments of the disclosure.

An example 301 of FIG. 3A shows an example of dividing N resource (or resources for slices) for each domain with respect to N service requests and providing a stitching service between domains. Referring to the example 301, resources of three domains 310, 320, and 330 may be mapped for N service requests. For example, each of the first domain 310, the second domain 320, and the third domain 330 may include N resource slices.

An example 302 of FIG. 3B shows an example of dividing K resources (or resources for slices) smaller than N for each domain with respect to N service requests and providing a stitching service between domains. Referring to the example 302, resources of three domains 310, 320, and 330 may be mapped for N service requests. For example, each of the first domain 310, the second domain 320, and the third domain 330 may include K resource slices. Unlike the example 301, the example 302 may include a mapper 340 for mapping K resource slices for each domain with respect to each of the N service requests. The mapper 340 may include a node for mapping a resource (or function) and a slice (or service) for each domain. The mapper 340 may be configured logically or physically. For example, the mapper 340 may include a switch, a virtual switch, a router, or a virtual router. In the example 302, it is illustrated that one mapper 340 is included for a plurality of domains 310, 320, and 330, but this is only for convenience of explanation, and embodiments of the disclosure are not limited thereto. For example, even if the number of resources for each domain is the same as K, different mappers may be configured for each domain.

In addition, an example 303 of FIG. 3B illustrates an example of dividing K_d1, K_d2, and K_d3 resource slices smaller than N for each domain with respect to N service requests and providing a stitching service between domains. Referring to the example 303, since the number of resources for each domain is different, a one-to-one teaching method may not be possible. Even if the number of resources divided for each domain is not the same between domains, embodiments of the disclosure may connect and control so that consistent characteristics are maintained on E2E. Referring to the example 303, for N service requests, resources of the three domains 310, 320, and 330 may be mapped. For example, the first domain 310 may include K_d1 resource slices. The second domain 320 may include K_d2 resource slices. The third domain 330 may include K_d3 resource slices. The example 303 may include mappers 341, 342, and 343 for mapping a resource slice for each domain with respect to each of the N service requests. For example, the mapper 343 may map a resource and a service request of the first domain 310. The mapper 342 may map a resource and a service request of the second domain 320. The mapper 341 may map a resource and a service request of the third domain 330. At this time, the service request may be transmitted to a mapper (e.g., a processing unit of the mapper) through packet header information. Alternatively, the service request may be transmitted to the mapper by being included in information on a resource to which a packet is transmitted.

Each of the mappers may include a node for mapping a resource (or function) and a slice (or service) for each domain. The mapper may be configured logically or physically. For example, the mapper may include a switch, a virtual switch, a router, or a virtual router.

The examples 301, 302, and 303 of FIGS. 3A and 3B illustrate an example of mapping resources of three domains 310, 320, and 330 to support N service requests, but embodiments of the disclosure are not limited thereto. For example, embodiments of the disclosure may also include a case of mapping a service and a resource with respect to one or more domains.

FIG. 4 illustrates an example of mapping between a resource and a tag for a network slice according to an embodiment of the disclosure.

Referring to FIG. 4, an example 400 illustrates an example of dividing a resource of each of three domains 410, 420, and 430 with respect to N service requests and providing a stitching service between domains. Referring to the example 400, resources of the three domains 410, 420, and 430 may be mapped for N service requests. For example, the first domain 410 may include two resource slices. The second domain 420 may include three resource slices. The third domain 430 may include four resource slices. The example 400 may include mappers 441, 442, and 443 for mapping a resource slice for each domain with respect to each of the N service requests. For example, the mapper 443 may map a service request with a first resource 411 and a second resource 412 of the first domain 410. The mapper 442 may map a service request with a first resource 421, a second resource 422, and a third resource 423 of the second domain 420. The mapper 441 may map a service request with a first resource 431, a second resource 432, a third resource 433, and a fourth resource 434 of the third domain 430. In this case, the service request may be transmitted as packet header information or information on a resource to which a packet is transmitted.

In an embodiment, identification information called a tag may be set on each resource slice to distinguish and manage resource slices for each domain as one set across several domains. For example, tag 1 and tag 2 may be configured for the first resource 411 of the first domain 410, and tag 3 and tag 4 may be configured for the second resource 412. For example, tag 1 may be configured for the first resource 421 of the second domain 420, tag 2 and tag 3 may be configured for the second resource 422, and tag 4 may be configured for the third resource 423. For example, tag 1 may be configured for the first resource 431 of the third domain 430, tag 2 may be configured for the second resource 432, tag 3 may be configured for the third resource 433, and tag 4 may be configured for the fourth resource 434. The identification information may also be referred to as an identifier, a sign, or a mark.

Referring to the above description, a mapper playing a role of connecting paths between both resource slices according to tags may be positioned between the domain and the domain. The mapper may receive tag-related information and mapping policy information from a tag policy manager. For example, if the mapper 441 associated with the third domain 430 receives a packet for a service corresponding to tag 1 from the DN, it may be transmitted to the first resource 431 corresponding to tag 1 and processed. The transmission and processing may be, for example, understood in the same manner as mapping the packet and the first resource 431 to the tag 1. The mapper 442 between the third domain 430 and the second domain 420 may identify a transmission end sign corresponding to the tag 1 from the third domain 430, and transmits the received packet to the first resource 421 corresponding to the tag 1 in the second domain 420 to process the same. It may be understood that the mapper 443 between the second domain 420 and the first domain 410 also performs the same operation as described above. Referring to the above description, since resources of each domain are divided into a plurality of tags, all packets transmitted by being distinguished by a specific tag may be processed.

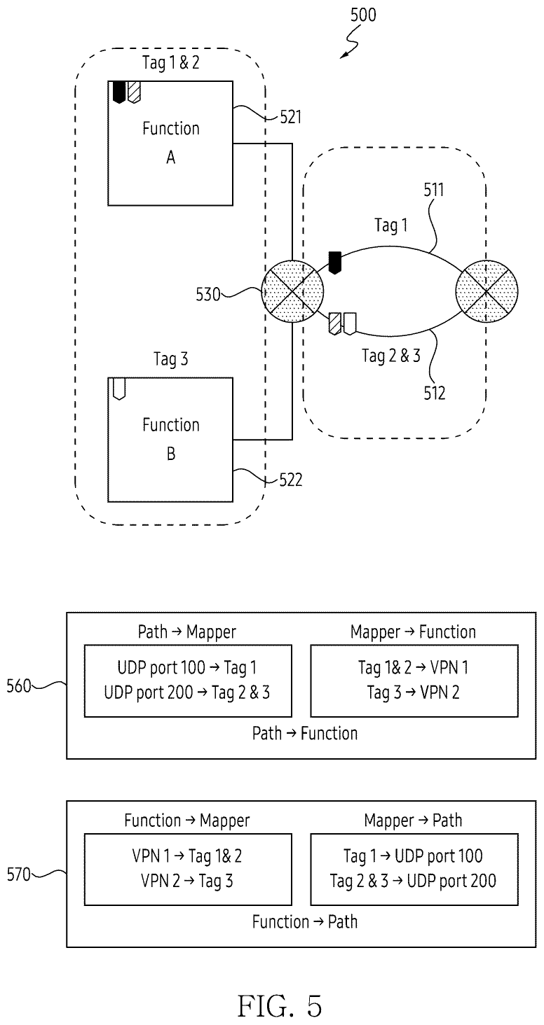

FIG. 5 illustrates an example of mapping between a function and a tag for a network slice according to an embodiment of the disclosure.

Referring to FIG. 5, examples 500, 560, and 570 illustrate examples of an operation of a mapper between a transport network and a processing system. Tag information may be indirectly distinguished by mapping with a sign in a transmission network or an operation system. In the transmission network, a path for transmitting packets may be set, and in the operation system, a function for processing packets may be arranged.

According to an embodiment, a path between the function and the outside may be tunneled through user datagram protocol (UDP) encapsulation. A UDP header may be defined as an outer header of a packet on a tunnel path. In the UDP header, port numbers may be set, and one of unused port numbers may be set for mapping with a tag. When the mapper receives a packet entering the operation system from the transmission network, the mapper may identify a port number in an outer user datagram protocol (UDP) header of the packet and identify it with a specific tag number by referencing a stored tag policy. When exporting in a direction of the operation system, the mapper may identify the stored tag policy and transmit the packet to a virtual private network (VPN) path mapped to the tag number. Even if a packet moves from a function of the operation system to the transmission network in a reverse direction, it may be understood to be substantially the same as the above operation of the mapper.

Referring to examples 500 and 560, according to an embodiment, in a case that a packet moves from the transmission network to the function, a mapper 530 may identify three tags for an incoming packet. For example, the mapper 530 may identify a packet 511 corresponding to UDP port 100 as tag 1, and a packet 512 corresponding to UDP port 200 as tag 2 and tag 3, based on a transmission network direction policy. The mapper 530 may export the distinguished tag and a packet entering UDP port number corresponding to the tag in a function direction. For example, based on a function direction policy, the mapper 530 may identify to transmit packets indicated with tags 1 and 2 to VPN 1 and packets indicated with tags 3 to VPN 2, and may export packets to corresponding VPN paths according to the tag number of the packet. The VPN path may be preset between the mapper 530 and the function, so that the packet exported from the mapper 530 is transmitted to a destination function. For example, the packet may be transmitted to function A 521 via VPN path 1 corresponding to the packet indicated with tags 1 and 2. The packet may be transmitted to function B 522 via VPN path 2 corresponding to the packet indicated with the tag 3. The VPN may be implemented in a VLAN scheme or a VxLAN scheme suitable for a virtualization environment.

Referring to examples 500 and 570, according to an embodiment, in a case that a packet moves from the function to the transmission network, the mapper 530 may identify three tags for an incoming packet. Based on the function direction policy, the mapper 530 may identify packets corresponding to the function A 521 corresponding to VPN 1 as tags 1 and 2, and packets corresponding to the function B 522 corresponding to VPN 2 as tag 3. Based on a transmission network direction policy for a tag corresponding to the VPN number of the incoming packet, the mapper 530 may modify it to the UDP port number and export it in the transmission network direction by referring to a designated Internet protocol (IP) address. For example, the mapper 530 may export packets indicated with tag 1 via UDP port 100, and packets indicated with tags 2 and 3 may be exported via UDP port 200. In FIG. 5, exporting means may indicate a transmission from a specific domain to another domain.

Referring to the above description, the device and method according to embodiments of the disclosure may dynamically switch tags and change the performance of PDU sessions, so that network features may be applied to PDU sessions. PDU sessions are generated for IP addresses, but the transmission network uses fields unrelated to IP addresses to map tag information, and the operation system uses virtual networks such as VPN based on tag information, so tag switching is possible while maintaining the PDU session. Since tag information is maintained even if the IP address changes due to handover between base stations due to the movement of the terminal, the device and method according to embodiments of the disclosure may freely change features of the RAN within target coverage according to the service requirement.

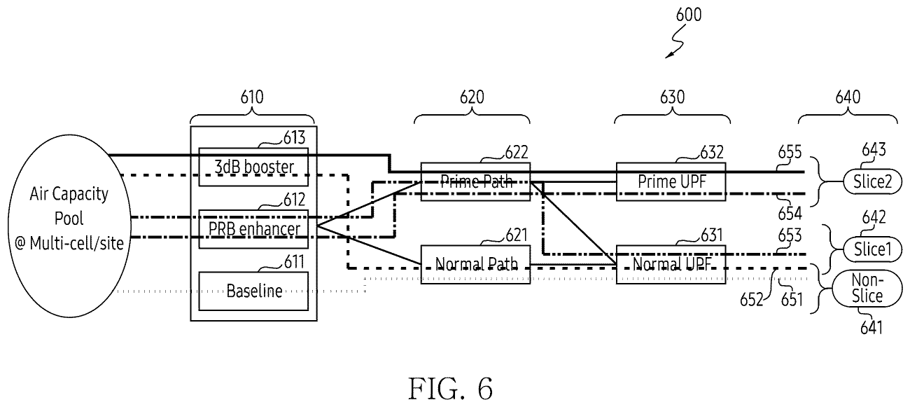

FIG. 6 illustrates an example of a logical connection relationship according to tag mapping for a plurality of domains according to an embodiment of the disclosure.

An example 600 of FIG. 6 illustrates an example of a mapping state between domains through tags for a plurality of domains 610, 620, 630, and 640. Referring to the example 600, a combination of resources/functions connected by the same tag across a plurality of domains 610, 620, 630, and 640 may be identified. For example, by combining functions (or facilities) 611, 612, and 613 with different features in the domain 610 related to the base station using tags, a plurality of base stations/cells in the coverage may provide the total air capacity provided to the terminal heterogeneously according to a desired function. Functions having different features in the domain 610 may include a 3 dB booster 613 that enhances the electric field by 3 dB, a physical resource block (PRB) enhancer 612 that further allocates physical resources, and a baseline 611. However, this is only an example for convenience of description, and embodiments of the disclosure are not limited thereto.

Referring to the example 600, according to an embodiment, PDU sessions of a terminal may correspond to a non-slice 641, a first slice 642, and a second slice 643 in a domain 640 related to DN. For example, a tag setting for the non-slice 641 may be identified as a tag 0 651 and a tag 1 652. When the electric field performance of the terminal is weakened in a state of operating as a tag 0 651 for the initial PDU session, a tag policy manager (not shown) may switch to the tag 1 652 for the non-slice 641 via a policy setting for a mapper of the domain 610. By the switching, the tag 0 packet entering the base station from the transmission end may be changed into the tag 1 packet. The changed packet may have enhanced electric field performance through the 3 dB booster 613 in the base station.

In an embodiment, referring to the example 600, in a state that tag 1 652 is set as the default for a PDU session for the first slice 642, the tag policy manager may switch the PDU session for a first slice 642 to a tag 2 653 through policy setting for the mapper of an area entering the domain 620 related to the transmission network. A packet transmitted through the PDU session passing through a general UPF 631 may be transmitted by changing from a general path 621 to a prime path 622 in the transmission network. In the example of changing from the general path 621 to the prime path 622, a protocol capable of dynamic path reconfiguration such as segment routing may be used for quality differentiation within the transmission network.

Referring to the example 600, in a state that the PDU session for the second slice 643 is set to a tag 3 654, the tag policy manager may switch the PDU session for the second slice 643 to a tag 4 655 through policy setting for the mapper of the domain 610. Accordingly, a packet transmitted through the PDU session passing through a prime UPF 632 and the prime path 622 may be changed to support the 3 dB booster 613 in the PRB enhancer 612.

Although not shown in the example 600 of FIG. 6, one tag may be mapped in common to different slices, or may be mapped in common between a slice and a general session (or non-slice). For example, the tag 0 651 and the tag 1 652 may be mapped to the non-slice 641, the tag 1 652 and the tag 2 653 may be mapped to the first slice 642, and the tag 3 654 and the tag 4 655 may be mapped to the second slice 643. In this case, unlike the example 600 of the tag 3 654, it may be mapped to the first slice 642.

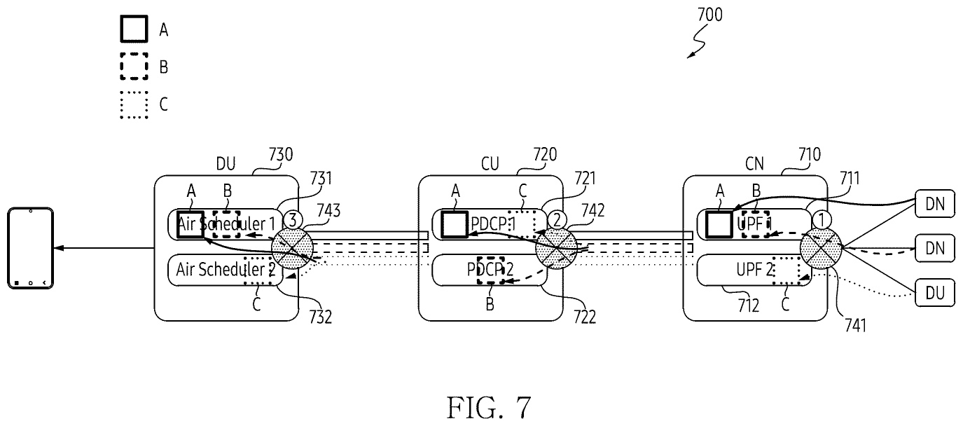

FIG. 7 illustrates an example of an operation of a mapper for setting a tag according to an embodiment of the disclosure.

Referring to FIG. 7, an example 700 illustrates operations of a mapper that may be logically or physically configured in a domain. Although not shown in the example 700, a mapper may be controlled based on information transmitted from a tag policy manager (not shown). In the example 700, a mapper 741 may perform tag mapping, a mapper 742 may perform tag switching, and a mapper 743 may perform tag splitting. Domains of the example 700 may include a core network (CN) 710, a central unit (CU) 720, and a distributed unit (DU) 730. However, embodiments of the disclosure are not limited thereto. For example, a domain according to a device and a method according to embodiments of the disclosure may include a transport network (TN) between the CN 710 and the CU 720 and a TN between the CU 720 and the DU 730. For example, in relation to a back-haul managed by the TN domain between the CU 720 and the CN 710, a mapper function may be set on a provider edge (PE) router from the CU 720 to the back-haul. Alternatively, in relation to a mid-haul managed by the TN domain between the CU 720 and the DU 730, a mapper function may be set on a router from the CU 720 to the mid-haul.

Referring to example 700, in relation to the tag mapping operation, the mapper 741 between a data network (DN) and the CN 710 may transfer packets to UPFs 711 and 712 mapped to tags that satisfy a service-key performance index (KPI) requested by the corresponding DN based on a data network name (DNN). Packets entering the CU 720 via a transmission network (TN) between the CN 710 and the CU 720 may be transferred from the mapper 742 to PDCPs 721 and 722 (or PDCP entities) distinguished by the tag in the CU 720. The tag may be set as tag A, tag B, and tag C. However, embodiments of the disclosure are not limited thereto. For example, the tags may be set to be divided into two or four or more.

Referring to the example 700, in relation to a tag switching operation, the mapper 742 that receives the packet processed to the tag B in the first UPF 711 may switch the packet to tag A by the tag policy manager identifying the deterioration of the performance of the second PDCP 722 while transferring it to the second PDCP 722 classified as tag B according to the existing setting. The mapper 742 may transmit a packet that is tag B among incoming packets to a VPN path from the mapper 742 to the first PDCP 721. The path switched to the tag A in the CU 720 may be maintained until the DU 730. Packets whose path is modified in the mapper 742 may be supported by a high-performance function (or facility) provided by a first Air Scheduler 731 in the DU 730. If the KPI of the slice mapped to the tag B is restored and maintained for a certain period of time, the tag policy manager may return the policy whose path was modified in the mapper 742 to the basic policy. For example, the method of returning to the basic policy may include that the tag policy manager directly instructs by a command, or instructs through an expiration event of a fallback timer set by the tag policy manager.

Referring to example 700, in relation to the tag-splitting operation, for packets entering the DU 730 classified as tag C, the tag policy manager may set a tag policy so that X % of packets maintain tag C and (100-X) % are switched to tag B, according to a rule established for the purpose of improving performance. Based on the policy, the mapper 743 may distribute and deliver to a first air scheduler 731 and a second air scheduler 732 at the ratio through a modular operation of the packet sequence number. The ratio may indicate a ratio according to time. For example, the ratio may indicate a ratio of distributing through dynamic switching every second for incoming packets.

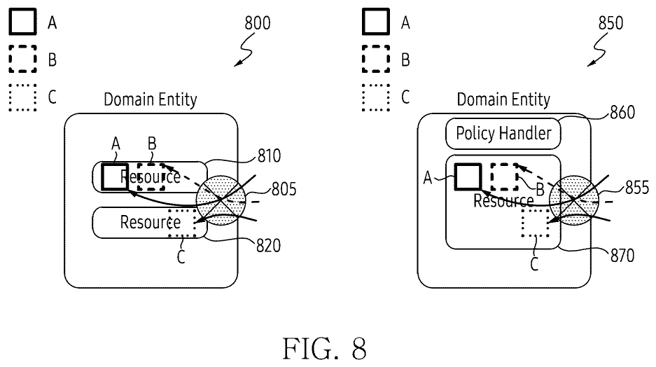

FIG. 8 illustrates an example of a method of mapping a tag to a resource or a policy according to an embodiment of the disclosure.

Examples 800 and 850 of FIG. 8 illustrate methods by which a mapper transfer a packet to a resource or function (or policy) corresponding to a tag based on tag information. Referring to the example 800, a mapper 805 may identify and transfer a packet to a resource (e.g., a virtual machine (VM), POD) corresponding to a tag. In the example 800, the mapper 805 may identify a tag sign of an incoming packet and apply a policy. If reconfiguration of the tag sign is required for tag switching or tag splitting, the mapper 805 may change a tag of the packet to correspond to a policy. The mapper 805 may transmit the packet to the IP address of a specific resource (VM/POD) through a VPN path corresponding to a tag reconfigured by reflecting the change. For example, if tags corresponding to the packet are tag A and tag B, the mapper 805 may transmit the packet to a resource 810 (or IP address corresponding to the resource 810). In addition, if the tag corresponding to the packet is tag C, the mapper 805 may transmit the packet to a resource 820 (or IP address corresponding to the resource 820).

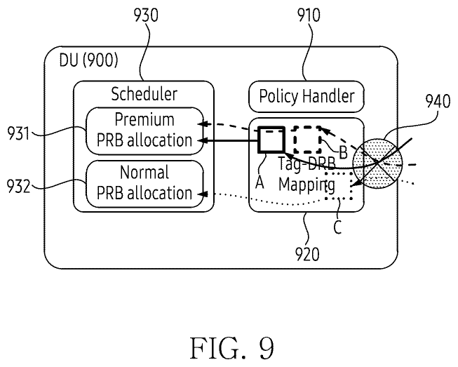

Referring to the example 850, the mapper 855 may share resources and identify and transfer a packet by a policy corresponding to the tag. A policy handler 860 within the domain may preset a tag policy according to resources. The mapper 855 may, for example, identify a tag sign of the incoming packet and transmit the packet to an IP address of resource (VM/POD) corresponding to the tag by establishing communication between resources (VM/POD) or implementing a function within the resource. The mapper 855 may store tag information of packets before processing, and may set a sign for the stored tag information when exporting a packet processed from the current resource to the outside and transmit it to another domain. In other words, referring to an example 850, the mapper 855 may primarily map packets incoming from the outside to the shared resource 870 regardless of tags. The packet may be secondarily mapped to a policy corresponding to each tag from the shared resource 870 in the domain. The secondary mapping may be performed by the mapper 855 or the policy handler 860. The contents related to this will be described in detail in FIGS. 9, 11, and 12.

FIG. 9 illustrates an example of a tag mapping method in a DU according to an embodiment of the disclosure.

According to an embodiment, a packet entering DU 900 may be tag mapped (or tag-to-capability mapping) with respect to a function within a resource. The example of FIG. 9 may indicate a case in which the packet is mapped to tags that share resources and are distinguished by a policy. A scheduler 930 in the DU 900 may map the differentiation for the terminal based on a data radio bearer (DRB) index. In order to utilize the DRB, primary tag mapping for packets entering the DU 900 from outside the DU 900 may be performed, and secondary tag mapping for the operation of the scheduler 930 in the DU 900 may be performed. In an example, the primary tag mapping may include that policy handler 910 identifying a tag corresponding to the UDP port number and mapping the DRB for the tag based on the policy. The secondary tag mapping may include transmitting the packet mapped to the DRB to the scheduler 930, and the scheduler 930 performing PRB allocation according to the DRB. The entire identifiers of the DRBs may be distinguished by pool units, by a result of modular operation of the DRB index by the total number of tags, or may be identified through the offset, which is the difference between DRBs.

Referring to FIG. 9, packets entering the DU 900 may share a resource 920. For example, the mapper 940 may map tag A, tag B, and tag C with respect to the packets, through the primary tag mapping. The policy handler 910 may transmit the packets mapped through the primary tag mapping to the scheduler 930 to perform the PRB allocation according to the DRB based on the policy. For example, packets corresponding to the tag A and the tag B may be transmitted to the scheduler 930 for premium PRB allocation 931. A packet corresponding to the tag C may be transmitted to the scheduler 930 for general PRB allocation 932. The premium PRB allocation 931 and the general PRB allocation 932 may be distinguished by pool unit, distinguished by a result of modular operation of a DRB index by the total number of tags, or identified based on the offset.

In the above-described example, it is illustrated that the primary tag mapping is performed by the mapper 940 and the secondary tag mapping is performed by the policy handler 910, but the embodiment of the disclosure is not limited thereto. For example, the primary tag mapping and the secondary tag mapping may be performed or controlled by the mapper 940 or the policy handler 910, based on tag information received from a tag policy manager (not shown).

In the above-described example, it is illustrated that the secondary tag mapping is performed by the policy handler 910 and the PRB allocation is differentiated, but the embodiments of the disclosure are not limited thereto. For example, according to the DRB classified as a result of the secondary tag mapping, the scheduler 930 may map and transmit signals to a specific frequency band. That is, the signal of the packet mapped to the tag A may be transferred in a low-band cell, and the signal of the packet mapped to the tag B may be transferred in a mid-band cell.

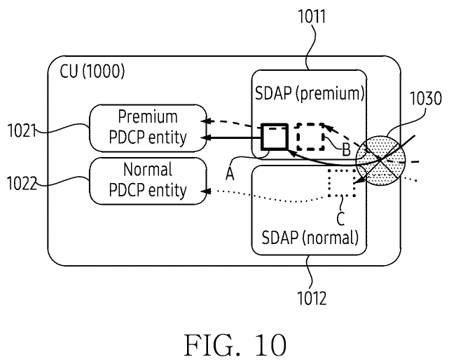

FIG. 10 illustrates an example of a tag mapping method in a CU according to an embodiment of the disclosure.

According to an embodiment, a packet entering the CU 1000 may be tag-mapped (or tag-to-capability mapping) with respect to a resource. The example of FIG. 10 may indicate a case in which the packet is classified by incoming resources. Based on tag mapping for packets entering the CU 1000 from outside the CU 1000, the packet may be transferred according to a policy for classifying a service data adaptation protocol (SDAP) in the CU 1000. For example, a mapper 1030 may transmit the incoming packet to a premium SDAP 1011 or a general SDAP 1012 according to the corresponding tag, based on the policy. The mapper 1030 may identify a tag corresponding to an external UDP port number and map a VPN path toward SDAPs 1011 and 1012 (or SDAP entities) for the tag, based on the policy. By identifying the received tag, the SDAPs 1011 and 1012 may set a tag sign on a packet transferred to packet data convergence protocols (PDCPs) 1021 and 1022, (or PDCP entities). Accordingly, the packets may be transferred to the corresponding PDCP entities 1021 and 1022.

Referring to FIG. 10, packets entering the CU 1000 may be transferred to different SDAPs according to resources. For example, the mapper 1030 may map the packets to tag A, tag B, and tag C, according to the external UDP port number. The mapper 1030 may transmit packets mapped to tag A and tag B to the premium SDAP 1011, and may transmit packets mapped to tag C to the general SDAP 1012. In another example, the premium SDAP 1011 may identify the tag A and tag B, and may transmit packets corresponding to the tag A and tag B to the premium PDCP 1021 based on the identified tag. For example, the general SDAP 1012 may identify the tag C and transmit a packet corresponding to the tag C to the general PDCP 1022 based on the identified tag.

In the above-described example, it is illustrated that the tag mapping is performed by the mapper 1030, but the embodiment of the disclosure is not limited thereto. For example, the tag mapping may be performed or controlled by a policy handler (not shown) within the mapper 1030 or the CU 1000, based on tag information received from a tag policy manager (not shown).

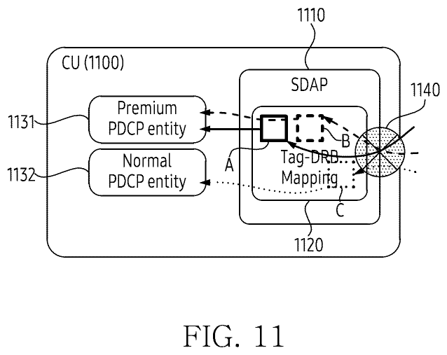

FIG. 11 illustrates another example of a tag mapping method in a CU according to an embodiment of the disclosure.

According to an embodiment, a packet entering CU 1100 may be tag-mapped (or Tag-to-Capability Mapping) with respect to a function within a resource. The example of FIG. 11 may indicate a case in which the packet is mapped to tags that share resources and are classified by a policy. SDAP 1110 in the CU 1100 may map differentiation for a quality of service (QOS) flow to a data radio bearer (DRB) index. In order to utilize the DRB, primary tag mapping may be performed on packets entering the CU 1100 from outside the CU 1100, and secondary tag mapping for performing an operation of the SDAP 1110 may be performed. For example, the primary tag mapping may include identifying a tag corresponding to a UDP port number in the SDAP 1110 and mapping a DRB for the tag based on a policy. In the secondary tag mapping, when the packet mapped to the DRB is transmitted to the PDCPs 1131 and 1132 (or PDCP entities), the PDCPs 1131 and 1132 may differently perform PDCP packet flow control operations according to the DRB. The entire identifiers of the DRBs may be distinguished by pool units or identified through an offset, which is difference between DRBs.

Referring to FIG. 11, packets entering the CU 1100 may share a resource 1120. For example, a mapper 1140 may map tag A, tag B, and tag C with respect to the packets through the primary tag mapping. The SDAP 1110 may transmit the packets mapped through the primary tag mapping to the PDCPs 1131 and 1132 to control the PDCP packet flow according to the DRB based on the policy. For example, packets corresponding to the tag A and the tag B may be transferred to the premium PDCP 1131. A packet corresponding to the tag C may be transferred to the general PDCP 1132. The premium PDCP 1131 and the general PDCP 1132 may be distinguished by the pool units, distinguished by a result of modular operation of a DRB index by the total number of tags, or identified based on the offset.

In the above-described example, it is illustrated that the primary tag mapping is performed by the mapper 1140 and the secondary tag mapping is performed by the SDAP 1110, but the embodiment of the disclosure is not limited thereto. For example, the primary tag mapping and the secondary tag mapping may be performed or controlled by the mapper 1140 or the SDAP 1110, based on tag information received from a tag policy manager (not shown).

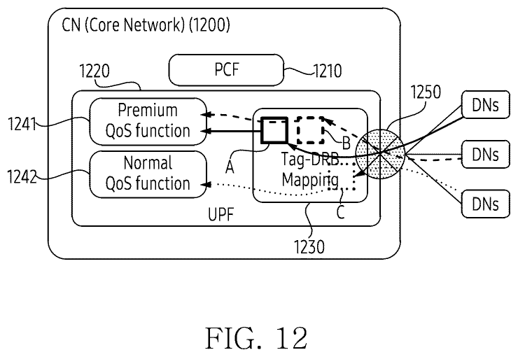

FIG. 12 illustrates an example of a tag mapping method in a CN according to an embodiment of the disclosure.

According to an embodiment, packets entering CN 1200 may be tag-mapped (or Tag-to-Capability Mapping) with respect to a function in resource. The example of FIG. 12 may indicate a case in which the packet is mapped to tags that share a resource and are classified by a policy. A policy control function (PCF) 1210 and the UPF 1220 in the CN 1200 may map differentiation for UE based on a QoS flow ID (QFI). The QoS flow ID may identify QoS class identifiers (QCI) in LTE, 5G QoS identifier (5QI) in NR, and profiles including a QoS characteristic and a policy for setting up with respect to the identified QCI/5QI. In order to utilize the QoS flow ID, primary tag mapping for packets entering the CN 1200 from outside the CN 1200 may be performed, and secondary tag mapping for differentiating the QoS flow ID may be performed. For example, the primary tag mapping may include identifying a tag corresponding to a data network name (DNN) within UPF 1220 and mapping a QoS flow ID for the tag based on a policy. The secondary tag mapping may include, for example, an operation of performing IP packet flow control according to a QoS flow ID corresponding to the QoS function within the UPF 1220 when a packet mapped to the QoS flow ID is transmitted to a QoS function. The entire identifiers of the QoS flow ID may be distinguished by pool units or identified through an offset, which is difference between the QoS flow IDs.

Referring to FIG. 12, packets entering the CN 1200 may share a resource 1230. For example, the mapper 1250 may map tag A, tag B, and tag C with respect to the packets through the primary tag mapping. The PCF 1210 may transmit the packets mapped through the primary tag mapping to the QoS functions 1241 and 1242 to perform the IP packet flow control according to the QoS flow ID, based on the policy. For example, packets corresponding to the tag A and the tag B may be transferred to the premium QoS function 1241. A packet corresponding to the tag C may be transferred to the general QoS function 1242. The premium QoS function 1241 and the general QOS function 1242 may be distinguished by the pool unit, by a result of modular operation of the QoS flow ID by the total number of tags, or may be identified by the offset.

In the above-described example, it is illustrated that the primary tag mapping is performed by the mapper 1250 and the secondary tag mapping is performed by the PCF 1210, but the embodiment of the disclosure is not limited thereto. For example, the primary tag mapping and the secondary tag mapping may be performed or controlled by the mapper 1250 or the PCF 1210 based on tag information received from a tag policy manager (not shown).

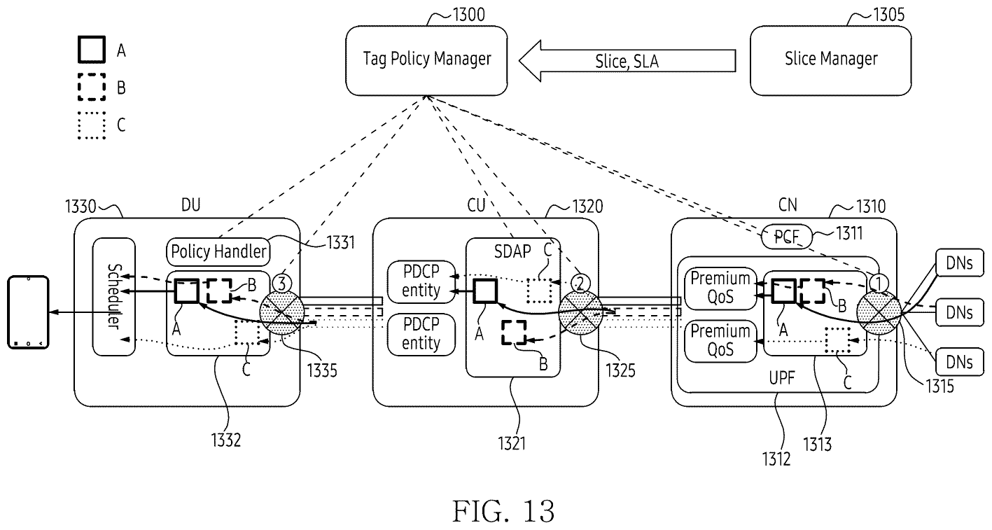

FIG. 13 illustrates an example in which a tag policy manager manages tag mapping for a plurality of domains according to an embodiment of the disclosure.

In embodiments of the disclosure, an entity that manages mapper operations, generates policies for tag mapping, and sets devices and resources for each domain may be referred to as a tag policy manager 1300. The tag policy manager 1300 is equipment for managing and setting tag-related policies for each domain at an upper level, and may include an interface for connecting mappers 1315, 1325, and 1335 and a policy handler 1331, SDAP 1321, and PCF 1311. The tag policy manager 1300 may generate, update, or delete a policy in device/resource/function in a domain through defined data schema and message signaling.

The tag policy manager 1300 may receive slice information including a slice ID and a service-level agreement (SLA) from the slice manager 1305 and generate and manage a tag-related policy. For example, the slice manager 1305 may include a network slice selection function (NSSF) and a network slice management function (NSMF).

The tag-related policy may include at least one of a policy to map a sign in transmission end/system/resource (e.g., IP, port, VPN ID, sign, namespace, and the like) to a tag or map a tag to a sign in transmission end/system/resource, a policy for a condition for switching tag, a policy for a condition for splitting tag, a policy to map a tag to a sign (or resource) within an application layer, and a policy to map a tag to a feature or capability (or function) of the network. The tag policy manager 1300 may manage a life cycle across a generation, maintenance, and deletion of policy, and control mappers and policy handlers (e.g., the policy handler 1331, the SDAP 1321, or the PCF 1311) for each domain. For example, the tag policy manager 1300 may control the mapper 1315 and the PCF 1311 of the CN 1310. For example, the CN 1310 may include UPF 1312. Packets entering the CN 1310 may share a resource 1313. In addition, the tag policy manager 1300 may control the mapper 1325 and the SDAP 1321 of the CU 1320. In addition, the tag policy manager 1300 may control the mapper 1335 and the policy handler 1331 of the DU 1330. For example, packets entering the DU 1330 may share a resource 1332. The SDAP 1321 of the CU 1320 and the PCF 1311 of the CN 1310 may indicate a standardized policy handler, and the policy handler 1331 of the DU 1330 may indicate a non-standardized implemented component.

Although not shown in FIG. 13, a domain controlled by the tag policy manager 1300 may not be limited to the CN 1310, the CU 1320, and the DU 1330. For example, a domain controlled by the tag policy manager 1300 may include a TN between the CN 1310 and the CU 1320 and a TN between the CU 1320 and the DU 1330.

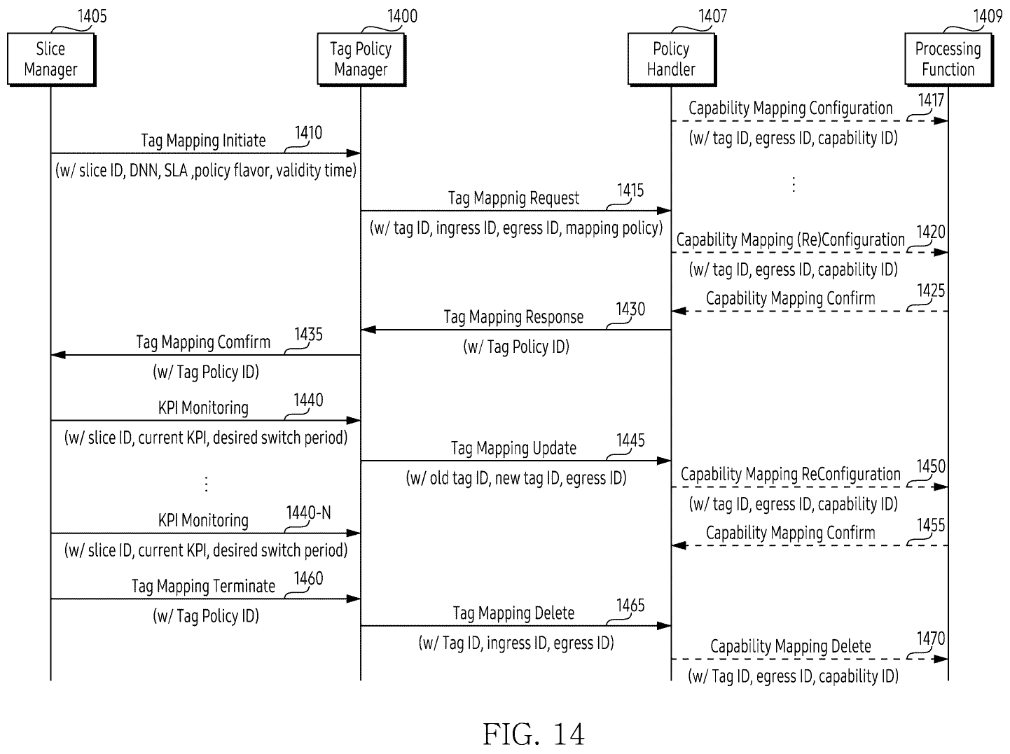

FIG. 14 illustrates an example of an operation flow in which a tag policy manager manages tag mapping according to an embodiment of the disclosure.

Referring to FIG. 14, an example of an operation of managing tag mapping and policy setting of a tag policy manager 1400 and a policy handler 1407 according to an embodiment is illustrated. For example, if a case that the policy handler 1407 is a standardized node such as an SDAP or a PCF, or a node for a de-facto standard such as a virtualization platform, a corresponding standard may be applied to a message for entering and executing a policy on equipment and function. The policy handler 1407 may include a non-standardized node.

FIG. 14 describes an example of an operation of setting and managing a policy in a function with respect to a policy handler 1407 including both standard and non-standard nodes. In operation 1417, in a case that the policy handler 1407 is a non-standardized node, a capability mapping configuration message transmitted by the policy handler 1407 to a processing function 1409 may be transmitted. For example, the capability mapping configuration message may be transmitted before a slice service is provided. The capability mapping configuration message may be, for example, transmitted in advance to prepare a resource for mapping. For example, the capability mapping configuration message may include at least one of a tag identifier (ID), an egress identifier (ID), or an ID for capability information (capability ID). Referring to the above description, operation 1417 of FIG. 14 may be omitted.

In operation 1410, the tag policy manager 1400 may receive a tag mapping initiate message from the slice manager 1405. For example, the tag mapping initiate message may include at least one of slice ID, data network number (DNN), SLA, service flavor, or validity time. The service flavor may include information for indicating whether to perform fixed mapping, to perform tag switching, to perform tag splitting, and whether to generate a policy by delegating to the tag policy manager 1400.

In operation 1415, the tag policy manager 1400 may transmit a tag mapping request message to the policy handler 1407. For example, the tag policy manager 1400 may identify an SLA of the requested slice and may identify a tag and a mapping policy based on the identified SLA and service flavor. The tag policy manager 1400 may transmit the tag mapping request message including information about the identified tag and mapping policy to the policy handler 1407. The tag mapping request message may include at least one of a tag ID, an ingress identifier (ingress ID), an egress identifier (egress ID), or a mapping policy corresponding to the identified tag. For example, the mapping policy may include whether to perform tag switching or tag splitting, a policy execution condition, and policy execution detail. Each of the ingress ID and egress ID may include a UDP port number, VPN, Label, DNN, QoS flow ID, and DRB.

According to an embodiment, the policy handler 1407 may upload and activate a corresponding policy to a node that processes policy execution, in response to receiving the tag mapping request message. Resources or functions that provide features and capabilities may be identified by a capability identifier (capability ID). Each a policy handler 1407 for each domain may transfer packets to a specific capability identifier based on the egress identifier. According to an embodiment, the policy handler 1407 may be configured singly in the mapper or may be configured in combination as an in-application policy handler 1407 that is separate from the mapper. The capability identifier may include a DRB and a QoS flow ID.

In operation 1420, the policy handler 1407 may transmit a capability mapping reconfiguration message to the function 1409. For example, in a case that a relationship between the egress identifier and the capability identifier is required to be changed, the policy handler 1407 may change the relationship by transmitting the capability mapping reconfiguration message to the function 1409. In operation 1425, the policy handler 1407 may receive a capability mapping confirm message from the function 1409. The capability mapping confirm message may include information for indicating that the capability mapping reconfiguration has been successful in response to the capability mapping reconfiguration message.

In operation 1430, the policy handler 1407 may transmitting a tag mapping response message to the tag policy manager 1400. If there is no problem with the capability mapping and tag mapping, the policy handler 1407 may transmit the tag mapping response message including the tag policy ID for management to the tag policy manager 1400. In operation 1435, the tag policy manager 1400 may transmit a tag mapping confirm message to the slice manager 1405 together with the tag policy ID.

In operation 1440 to operation 1440-N, the slice manager 1405 may periodically transmit a KPI monitoring message to the tag policy manager 1400. For example, the slice manager 1405 may periodically measure the performance of the slice and include the measured information in a KPI monitoring message and transmit it to the tag policy manager 1400 periodically. For example, the KPI monitoring message may include at least one of a slice ID, a current KPI, or a desired switch period.

In operation 1445, the tag policy manager 1400 may transmit a tag mapping update message to the policy handler 1407. According to an embodiment, the tag policy manager 1400 may identify whether tag switching is required by identifying a tag ID and policy supporting a slice ID based on the received KPI monitoring message. When tag switching is required, the tag policy manager 1400 may transmit a tag mapping update message to the policy handler 1407 in accordance with a possible period considering the desired switching period. In an embodiment, the tag mapping update message may include at least one of an old tag ID, a new tag ID, or an egress identifier (egress ID). The policy handler 1407 that receives the tag mapping update message may reconfigure the capability mapping and tag mapping by transmitting a capability mapping reconfiguration message to the function 1409 through the operation 1450 and the operation 1455 and receiving a capability mapping confirm message from the function 1409. Accordingly, the policy handler 1407 may update the new tag ID and the egress ID in an egress policy among the policy information related to the old tag ID.

In operation 1460, the slice manager 1405 may transmit a tag mapping terminate message to the tag policy manager 1400. For example, if the slice manager 1405 identifies that tag mapping is no longer needed, the slice manager 1405 may transmit a tag mapping terminate message to the tag policy manager. The tag mapping terminate message may include a tag policy ID. In operation 1465, the tag policy manager 1400 may transmit a tag mapping delete message to the policy handler 1407, in response to receiving the tag mapping terminate message. In addition, in operation 1470, the policy handler 1407 may transmit a capability mapping delete message to the function 1409. The capability mapping delete message may include at least one of a tag ID, an egress ID, or a capability ID.

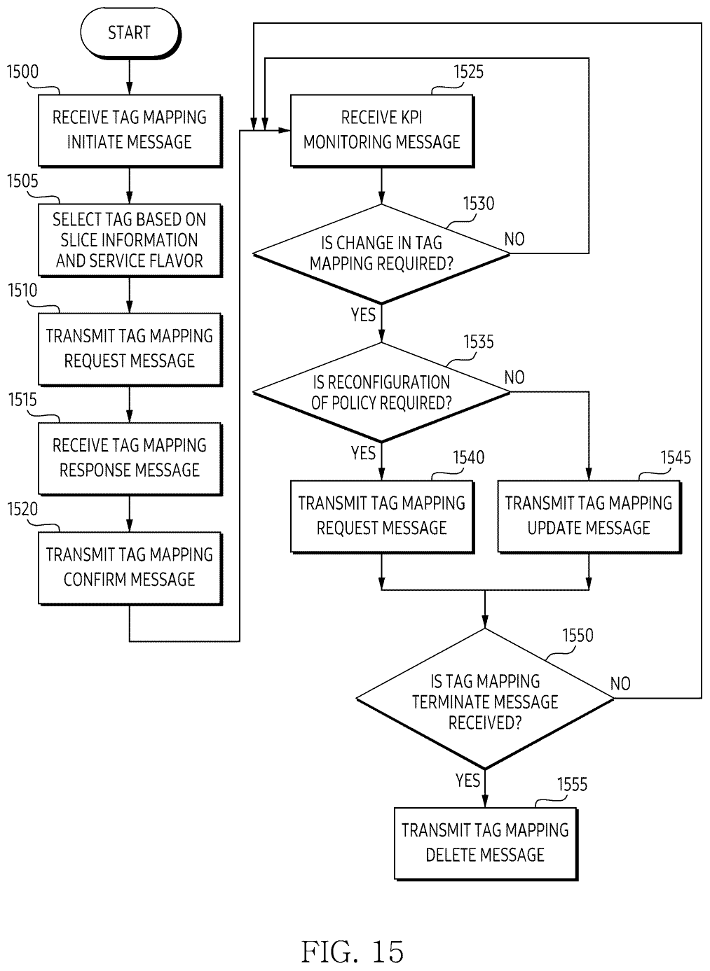

FIG. 15 is a flowchart illustrating an example of a method in which a tag policy manager manages tag mapping according to an embodiment of the disclosure.

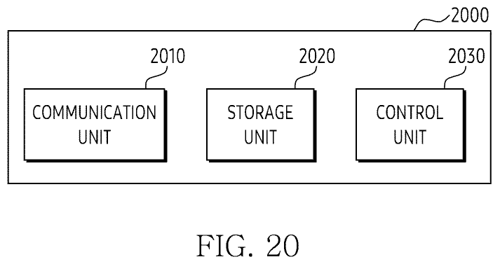

The flowchart of FIG. 15 illustrates an example of an operation flow of the tag policy manager 1400 of FIG. 14 for managing tag mapping and policy setting. Accordingly, the method of FIG. 15 may be performed by the tag policy manager 1400. For example, the operations of FIG. 15 may be performed by a control unit 2030 of FIG. 20 illustrating an example of a configuration of the tag policy manager 1400.

In operation 1500, the tag policy manager 1400 may receive a tag mapping initiate message. For example, the tag policy manager 1400 may receive the tag mapping initiate message from a slice manager (e.g., the slice manager 1405 of FIG. 14). For example, the tag mapping initiate message includes at least one of a slice ID, a data network number (DNN), an SLA, a service flavor, or a validity time. The service flavor may include information for indicating whether to perform fixed mapping, whether to perform tag switching, whether to perform tag splitting, and whether to generate a policy by delegating to the tag policy manager.

In operation 1505, the tag policy manager 1400 may select one or more tags based on slice information and service flavor. For example, the tag policy manager 1400 may identify one or more tags based on information included in the tag mapping initiate message. If tag switching or tag splitting is requested as a service flavor, the tag policy manager 1400 may identify a plurality of tags.

In operation 1510, the tag policy manager 1400 may transmit a tag mapping request message including information about the selected tag to a policy handler (e.g., the policy handler 1407 of FIG. 14). The tag mapping request message may include at least one of a tag ID, an ingress identifier (ingress ID), an egress identifier (egress ID), or a mapping policy corresponding to the identified tag. For example, the mapping policy may include whether to perform tag switching or tag splitting, a policy execution condition, and policy execution detail. Each of the ingress ID and the egress ID may include a UDP port number, VPN, Label, DNN, QoS flow ID, and DRB. The policy handler may be set for each domain. The domain may include a CN, a CU, a DU, and a TN.

In operation 1515, the tag policy manager 1400 may receive a tag mapping response message. For example, the tag policy manager 1400 may receive the tag mapping response message from the policy handler. According to receiving the tag mapping response message, the tag policy manager 1400 may manage the mapping information and policy as a single tag policy ID.

In operation 1520, the tag policy manager 1400 may transmit a tag mapping confirm message including a tag policy ID to an upper device (e.g., the slice manager 1405 of FIG. 14).

In operation 1525, the tag policy manager 1400 may receive a key performance indicator (KPI) monitoring message from the upper device. The tag policy manager 1400 may periodically receive a KPI monitoring message from the slice manager.

In operation 1530, the tag policy manager 1400 may identify whether a change in tag mapping is required. For example, the tag policy manager 1400 may identify whether to switch tags based on the received KPI monitoring message. In operation 1530, if it is identified that a change in tag mapping is not required, the tag policy manager 1400 may perform operation 1525 again. In operation 1530, if it is identified that a change in tag mapping is required, the tag policy manager 1400 may perform operation 1535.

In operation 1535, the tag policy manager 1400 may identify whether to reconfigure the policy. In operation 1535, if it is identified that reconfiguration of the policy is required, the tag policy manager 1400 may perform operation 1540. Alternatively, if it is identified that reconfiguration of the policy is not required, the tag policy manager 1400 may perform operation 1545.

In operation 1540, the tag policy manager 1400 may transmit a tag mapping request message to the policy handler according to identifying that a change in tag mapping and reconfiguration of the policy are required.

In operation 1545, if it is determined that reconfiguration of the policy is not required but switching of tag mapping is required, the tag policy manager 1400 may transmit a tag mapping update message to the policy handler.

In operation 1550, the tag policy manager 1400 may identify whether a tag mapping terminate message has been received. If the tag mapping terminate message has been received, the tag policy manager 1400 may transmit a tag mapping delete message to the policy handler in operation 1555. If the tag mapping terminate message has not been received, the tag policy manager 1400 may return to operation 1525 and identify whether a KPI monitoring message has been received. The KPI monitoring message may include information identified by the slice manager and may be periodically transmitted from the slice manager to the tag policy manager 1400.

According to an embodiment, as a method of using an IP header when transmitting a packet, the mapper may transmit a packet including IP information including tag information as follows.
internet protocol version 4 (IPv4): differentiated services code point (DSCP) marking with tag information
internet protocol version 6 (IPv6): Flow labeling with tag information

Which protocol is used among IPv4/IPv6 may be identified by the network settings. A mapper (e.g., a switch or a router) that receives an IP packet including the tag information may identify a tag to which the packet belongs using information included in the IP header. The mapper, such as a switch, a router, or a function implementation, may perform packet transmission control according to the set tag policy.

According to an embodiment, a gprs tunneling protocol user plane (GTP-U) header of the N3/N9 section may be used to inform tag information to which the packet belongs. The GTP-U Header may include a service class indicator (SCI) field. When the UPF or NG-RAN transmits a packet to the next hop (e.g., UPF or NG-RAN), the tag information may be included in the SCI Field of the GTP-U Header.

A mid-path mapper (switch or router) may not process the GTP-U header. If tag-specific packet processing is required, the SCI Field included in the GTP-U Header is required to be detected by the intermediate switch/router. In a case that the tag information is included in the GTP-U header, the UPF or NG-RAN may transmit, by including in the IP packet header including the GTP-U packet, information as follows that indicates that the SCI field of the GTP-U header needs to be processed or that a tag-based packet processing function is required.
IPV4: DSCP marking with “per tag packet processing is needed” or “SCI in GTP-U header” indication
IPv6: Flow labeling with “per tag packet processing is needed” or “SCI in GTP-U header” indication

A switch or router in the N3/N9 transmission path may receive an IP packet, and if the information is set in the IP header, read the SCI field of the GTP-U header and identify the tag to which the packet belongs. A mapper, such as a switch or router or a function implementation, may perform packet transmission control according to the set tag-specific packet processing policy.

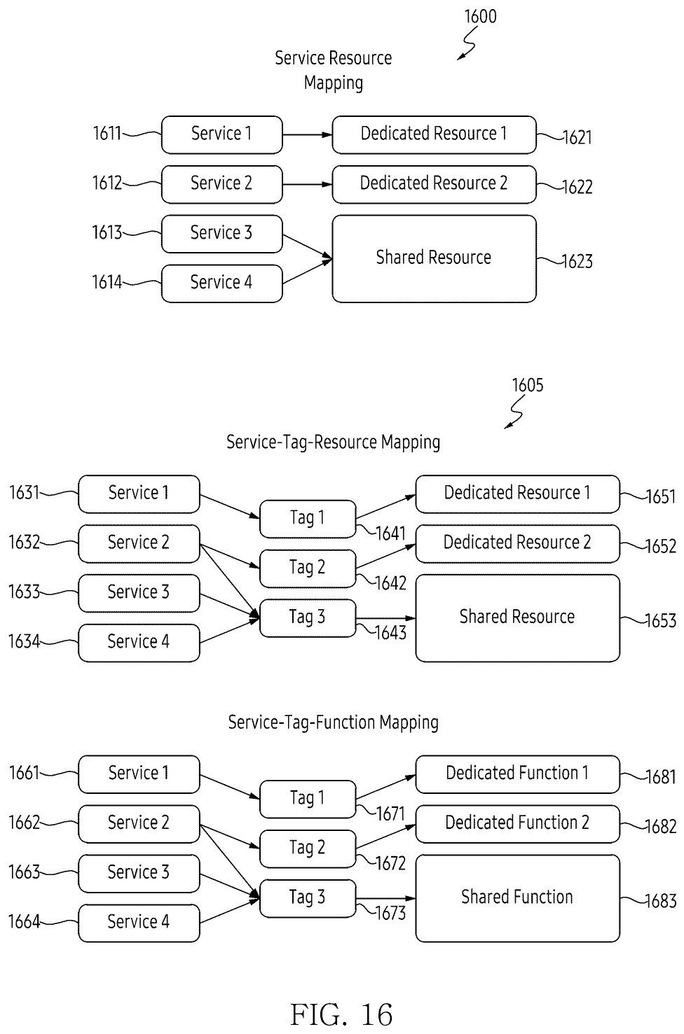

FIG. 16 illustrates examples of a mapping relationship between a service and a resource or function according to an embodiment of the disclosure.

Referring to FIG. 16, an example 1600 illustrates a management structure that performs direct mapping between a slice and a resource, which is a service in an existing 3GPP standard specification, and example 1605 illustrates a management structure that performs indirect mapping between a service and a resource (or function) based on a tag, which is an identification sign according to an embodiment of the disclosure.

Referring to the example 1600, a first service 1611 may be mapped to a first resource 1621, a second service 1612 may be mapped to a second resource 1622, and a third service 1613 and a fourth service 1614 may be mapped to a shared resource 1623.

Referring to the example 1605, in a service-tag-resource mapping example, a first service 1631 may be mapped to a first tag 1641, a second service 1632 may be mapped to a second tag 1642 and a third tag 1643, and a third service 1633 and a fourth service 1634 may be mapped to a third tag 1643. In addition, the first tag 1641 may be mapped to a first resource 1651, the second tag 1642 may be mapped to a second resource 1652, and the third tag 1643 may be mapped to a shared resource 1653.

Referring to the example 1605, in a service-tag-function mapping example, a first service 1661 may be mapped to a first tag 1671, a second service 1662 may be mapped to a second tag 1672 and a third tag 1673, and a third service 1663 and a fourth service 1664 may be mapped to the third tag 1673. The first tag 1671 may be mapped to a first function 1681, the second tag 1672 may be mapped to a second function 1682, and the third tag 1673 may be mapped to a shared function 1683. The function may also be referred to as a policy or a capability.

Referring to the above description, since a tag is positioned between a service and a resource (or function) and serves as an intermediary, a degree of freedom for fixed mapping relationship between a service and a resource may be increased. For example, if a service and a resource are directly mapped as in the example 1600, a separate allocation resource should be provided according to service KPI. However, if a tag exists between the service and the resource, direct mapping between the tag and the resource is still static resource allocation, but mapping between the service and the tag may be dynamically switched to maintain performance that satisfies a targeted service KPI.

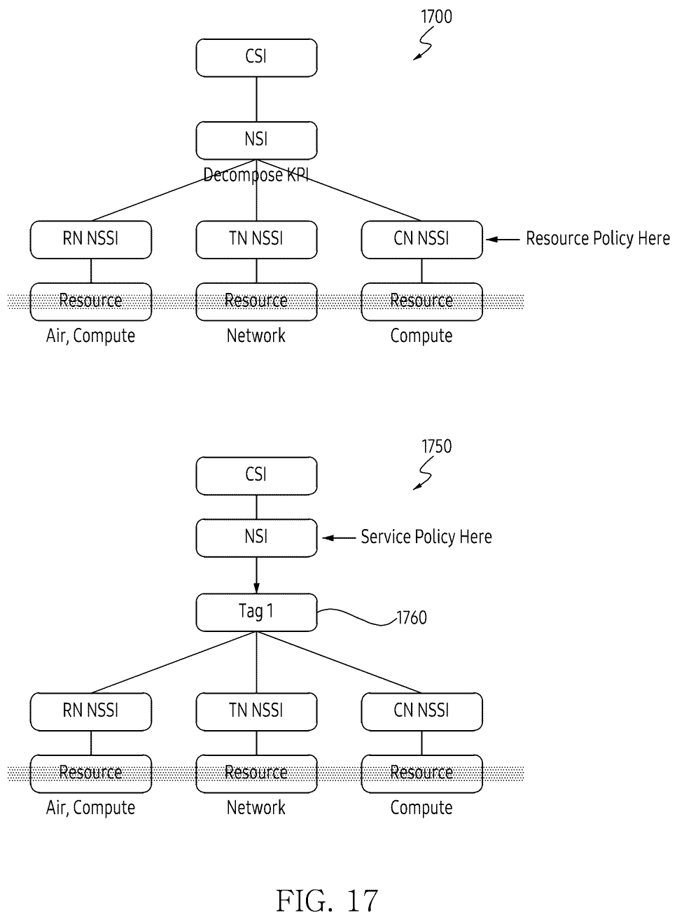

FIG. 17 illustrates examples of a network slice management structure according to an embodiment of the disclosure.

Referring to FIG. 17, an example 1700 illustrates an example of slice resource allocation of a 3GPP management domain without using tag. In contrast, an example 1750 illustrates an example of slice resource allocation of a 3GPP management domain using a tag according to an embodiment of the disclosure.

Referring to the example 1700, the 3GPP slice resource allocation may include requesting each domain-specific slice manager to generate instances (e.g., RN NSSI, TN NSSI, CN NSSI) by decomposing CSI-NSI mapping and target KPI at an end-to-end (E2E) level. Therefore, resource management such as resource increase/decrease entirely depends on the domain-specific orchestrator and the domain-specific resource policy.

On the other hand, referring to the example 1750, it may be a state in which NSI and a tag 1760 are mapped using the tag and the tag 1760 is allocated resources for target performance across a plurality of domains in advance. Therefore, in the example 1750, a separate KPI decomposition process may not be required. In a case of the example 1750, service assurance may be provided by appropriately selecting a tag (e.g., the tag 1750) only with the service policy managed by NSI.

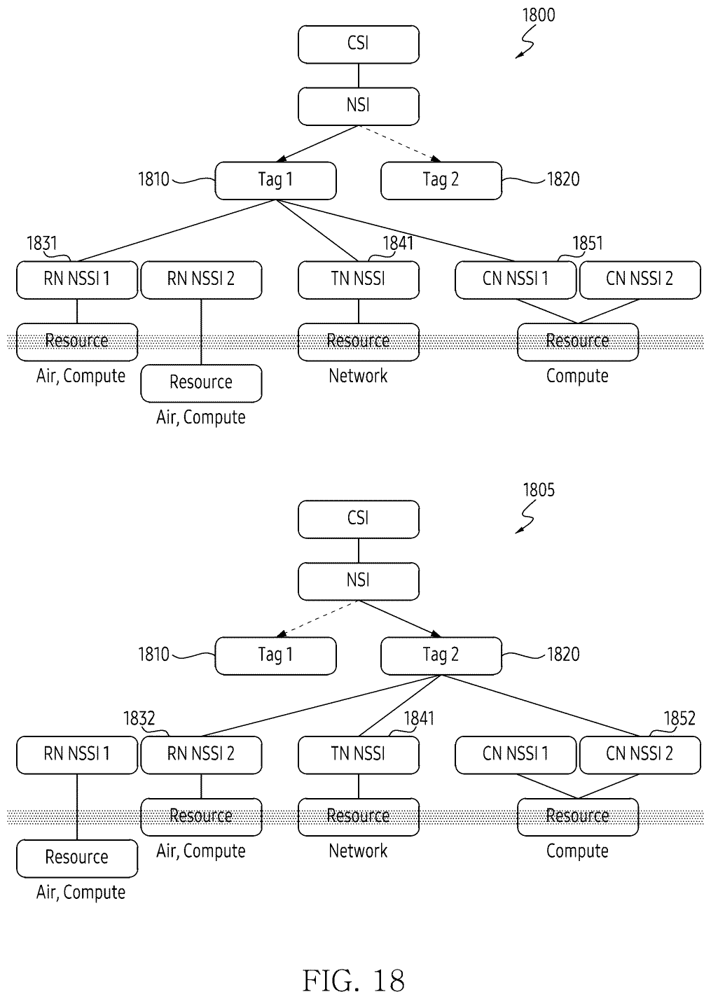

FIG. 18 illustrates examples of a network slice management structure based on a plurality of tags according to an embodiment of the disclosure.

FIG. 18 illustrates examples 1800 and 1805 using a plurality of tags in a method of mapping a slice (or service) and a resource (or function) using a tag according to an embodiment of the disclosure, as in the example 1750 of FIG. 17. The example 1800 illustrates an example of mapping a slice and a resource using a first tag 1810 mapped to CSI and NSI, and the example 1805 illustrates an example of mapping a slice and a resource using a second tag 1820 mapped to CSI and NSI.

Referring to the example 1800, NSI may be mapped to the first tag 1810. The first tag 1810 may be mapped to a resource instance of each of a plurality of domains. For example, the first tag 1810 may be mapped to a first RN NSSI 1831, a TN NSSI 1841, and a first CN NSSI 1851. Each of the first RN NSSI 1831, the TN NSSI 1841, and the first CN NSSI 1851 may be mapped to a resource in each domain.

Referring to the example 1805, NSI may be mapped to the second tag 1820. The second tag 1820 may be mapped to a resource instance of each of a plurality of domains. For example, the second tag 1820 may be mapped to a second RN NSSI 1832, a TN NSSI 1841, and a second CN NSSI 1852. Each of the second RN NSSI 1832, the TN NSSI 1841, and the second CN NSSI 1852 may be mapped to a resource in each domain.

Resources mapped through the TN NSSI 1841 may be the same in the first tag 1810 of the example 1800 and the second tag 1820 of the example 1805. A resource to which the first RN NSSI 1831 of the first tag 1810 is mapped may be different from a resource to which the second RN NSSI 1832 of the second tag 1820 is mapped. In addition, the first CN NSSI 1851 of the first tag 1810 may have an instance different from the second CN NSSI 1852 of the second tag 1820, but the mapped resources may be the same. In a case of using a plurality of tags, a resources and characteristic/capability for a PDU session may be changed simply by switching mapping of NSI and tags with respect to the E2E resource combination configured by each tag in advance. The tag policy manager may use a slice manager for each domain to generate an instance for a resource to suit the service requirement of the tag.

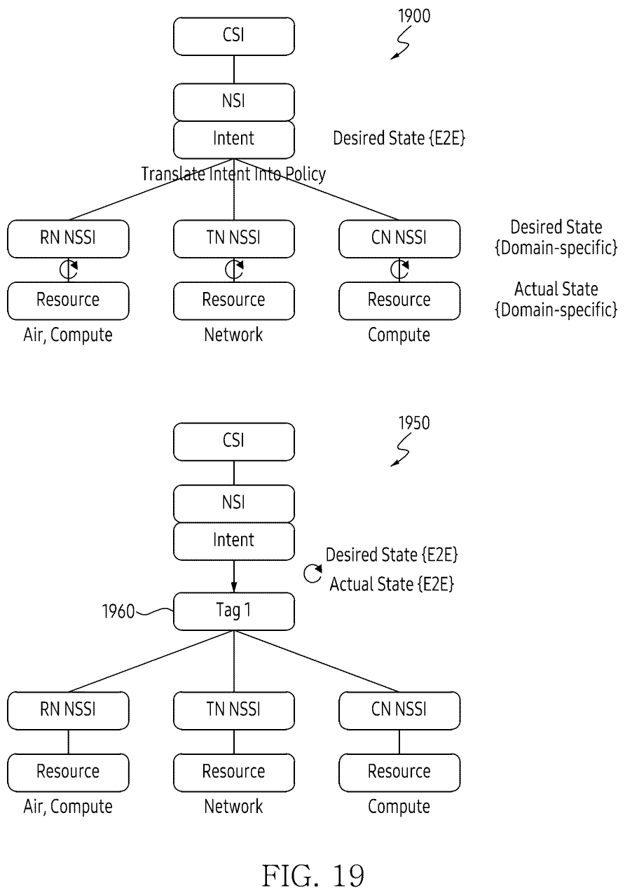

FIG. 19 illustrates examples of an intent-based network slice management structure according to an embodiment of the disclosure.

Referring to FIG. 19, an example 1900 illustrates an example of slice resource allocation of an intent-based 3GPP management domain in a case that a tag is not used. Alternatively, an example 1750 illustrates an example of slice resource allocation of an intent-based 3GPP management domain using a tag, according to an embodiment of the disclosure.

Referring to the example 1900, the 3GPP slice resource allocation may include a suitable instance generate request mapped to a resource to each domain slice manager by translating an end-to-end (E2E) level of CSI-NSI mapping and target KPI into a policy. For example, an intent handler (not shown) may translate and provide intent according to knowledge-based recommendation into domain-specific policies.

On the other hand, referring to the example 1950, it may be a state in which NSI and specific intent and a tag 1960 are mapped using a tag, and the tag 1960 is allocated resources for target performance across a plurality of domains in advance. Therefore, the example 1950 may not require a process of translating an intent according to a separate knowledge-based recommendation into a policy. In a case of the example 1950, a service assurance may be provided by selecting a tag (e.g., the tag 1960) corresponding to the intent.

FIG. 20 illustrates an example of a configuration of a device in a wireless communication system according to an embodiment of the disclosure.

Referring to FIG. 20, a device 2000 may include a communication unit 2010, a storage unit 2020, and a control unit 2030. The device 2000 may include an entity, a node, and a network function (NF). For example, the device 2000 may include a tag policy manager (e.g., the tag policy manager 1400 of FIG. 14), a slice manager 1405 and a policy handler 1407 according to embodiments of the disclosure. In other words, FIG. 20 may be understood as an example of a configuration included in an entity such as a tag policy manager according to embodiments of the disclosure.

The communication unit 2010 provides an interface for performing communication with other devices in a network. That is, the communication unit 2010 converts a bit stream transmitted from the device 2000 to another device into a physical signal, and converts a physical signal received from another device into a bit stream. That is, the communication unit 2010 may transmit and receive a signal. Accordingly, the communication unit 2010 may be referred to as a modem, a transmitter, a receiver, or a transceiver. At this time, the communication unit 2010 enables the device 2000 to communicate with other devices or systems through a backhaul connection (e.g., wired backhaul or wireless backhaul) or through a network.

The storage unit 2020 stores data such as a basic program, an application program, and setting information for operations of the device 2000. The storage unit 2020 may be composed of a volatile memory, a nonvolatile memory, or a combination of a volatile memory and a nonvolatile memory. In addition, the storage unit 2020 provides stored data according to a request of the control unit 2030.

The control unit 2030 controls overall operations of the device 2000. For example, the control unit 2030 transmits and receives a signal through the communication unit 2010. In addition, the control unit 2030 records and reads data in the storage unit 2020. To this end, the control unit 2030 may include at least one processor. According to various embodiments, the control unit 2030 may control to perform synchronization using a wireless communication network. For example, the control unit 2030 may control the device 2000 to perform operations according to various embodiments described above.

Referring to FIGS. 1A, 1B, 2, 3A, 3B, 4 to 19, and 20, a device and a method for identifying a resource for a network slice according to an embodiment of the disclosure may improve efficiency of resource allocation by using a tag playing a role of an intermediary between a slice and a resource (or function). The device and the method for identifying a resource for a network slice according to an embodiment of the disclosure may provide a resource (or function) corresponding to various services even in a fixed mapping relationship between a tag and a resource (or function) by converting a dynamic mapping relationship between a tag and a slice. In other words, the device and the method for identifying a resource for a network slice according to an embodiment of the disclosure may increase a degree of freedom for a fixed mapping relationship between a service and a resource by placing a tag between a service and a resource (or function) to play a role of an intermediary.

As described above, a method performed by a first entity may comprise receiving, from a second entity for managing a network slice, an initiate message including network slice information. The method may comprise, based on the network slice information, transmitting, to a first node of a first domain, a request message including an identifier for indicating a tag, an ingress identifier, an egress identifier, and information on a policy associated with the tag. The method may comprise receiving, from the first node, a response message corresponding to the request message. The ingress identifier may comprise an identifier indicating a second domain for transmitting a packet to the first domain. The egress identifier may comprise an identifier indicating a third domain for receiving the packet from the first domain. The tag may be an identifier for mapping an in-domain resource for the packet and at least one network slice associated with the packet.

According to an embodiment, the second entity may comprise a network slice selection function (NSSF) and a network slice management function (NSMF). The first domain may comprise a core network. The first node may comprise a policy control function (PCF).

According to an embodiment, the second domain may comprise a data network. The third domain may comprise a central unit (CU) of an access network (AN).

The method may comprise identifying at least one tag based on the information on the network slice included in the initiate message. The method may comprise transmitting the request message including an identifier for indicating the at least one tag and information on a policy associated with the at least one tag, to the first node.

According to an embodiment, the response message may include a tag policy identifier. The method may comprise transmitting a confirmation message including the tag policy identifier to the second entity. The tag policy identifier may be identified based on mapping information between the tag and a resource, and information on the policy associated with the tag.

According to another embodiment, the method may comprise receiving, from the second entity, a key performance indicator (KPI) monitoring message. The KPI monitoring message may include a network slice identifier, a KPI value, and a switching period.

According to an embodiment, the method may comprise identifying whether a change of the at least one tag is needed, based on the KPI monitoring message. The method may comprise, in response to identifying that the change is needed, identifying whether a reconfiguration of a policy associated with the changed tag is needed.

The method may comprise, in response to identifying that the reconfiguration of the policy is needed, transmitting another request message to the first node. The method may comprise, in response to identifying that the reconfiguration of the policy is not needed, transmitting an update message to the first node. The another request message may include an identifier for indicating the changed tag, the ingress identifier, the egress identifier, and information on a policy associated with the changed tag. The update message may include an identifier for indicating the at least one tag, the changed identifier, and the egress identifier.

According to an embodiment, the method may comprise, receiving, from the second entity, a terminate message. The terminate message may include the tag policy identifier.

According to another embodiment, the ingress identifier may include at least one of a user datagram protocol (UDP) port number, a virtual private network (VPN), a data network name (DNN), a label, a data radio bearer (DRB), or a quality of service (QOS) flow identity (ID). The egress identifier may include at least one of a UDP port number, a VPN, a label, a DNN, a namespace, a DRB, or a QoS flow ID.

As described above, a first entity may comprise memory storing instructions. The first entity may comprise a transceiver. The first entity may comprise a processor. The instructions, when executed by the processor, may cause the first entity to receive, from a second entity for managing a network slice, an initiate message including network slice information. instructions, when executed by the processor, may cause the first entity to transmit, to a first node of a first domain, a request message including an identifier for indicating a tag, an ingress identifier, an egress identifier, and information on a policy associated with the tag, based on the network slice information. instructions, when executed by the processor, may cause the first entity to receive, from the first node, a response message corresponding to the request message. The ingress identifier may comprise an identifier indicating a second domain for transmitting a packet to the first domain. The egress identifier may comprise an identifier indicating a third domain for receiving the packet from the first domain. The tag may be an identifier for mapping an in-domain resource for the packet and at least one network slice associated with the packet.

According to an embodiment, the second entity may comprise a network slice selection function (NSSF) and a network slice management function (NSMF). The first domain may comprise a core network. The first node may comprise a policy control function (PCF).

According to an embodiment, the second domain may comprise a data network. The third domain may comprise a central unit (CU) of an access network (AN).

According to another embodiment, the instructions, when executed by the processor, may cause the first entity to identify at least one tag based on the information on the network slice included in the initiate message. The instructions, when executed by the processor, may cause the first entity to transmit the request message including an identifier for indicating the at least one tag and information on a policy associated with the at least one tag, to the first node.

According to yet another embodiment, the response message may include a tag policy identifier. The instructions, when executed by the processor, may cause the first entity to transmit a confirmation message including the tag policy identifier to the second entity. The tag policy identifier may be identified based on mapping information between the tag and a resource, and information on the policy associated with the tag.

According to an embodiment, the instructions, when executed by the processor, may cause the first entity to receive, from the second entity, a key performance indicator (KPI) monitoring message. The KPI monitoring message may include a network slice identifier, a KPI value, and a switching period.

According to an embodiment, the instructions, when executed by the processor, may cause the first entity to identify whether a change of the at least one tag is needed, based on the KPI monitoring message. The instructions, when executed by the processor, may cause the first entity to, in response to identifying that the change is needed, identify whether a reconfiguration of a policy associated with the changed tag is needed.

According to an embodiment, the instructions, when executed by the processor, may cause the first entity to, in response to identifying that the reconfiguration of the policy is needed, transmit another request message to the first node. The instructions, when executed by the processor, may cause the first entity to, in response to identifying that the reconfiguration of the policy is not needed, transmit an update message to the first node. The another request message may include an identifier for indicating the changed tag, the ingress identifier, the egress identifier, and information on a policy associated with the changed tag. The update message may include an identifier for indicating the at least one tag, the changed identifier, and the egress identifier.

According to an embodiment, the instructions, when executed by the processor, may cause the first entity to receive, from the second entity, a terminate message. The terminate message may include the tag policy identifier.

The ingress identifier may include at least one of a user datagram protocol (UDP) port number, a virtual private network (VPN), a data network name (DNN), a label, a data radio bearer (DRB), or a quality of service (QOS) flow identity (ID). The egress identifier may include at least one of a UDP port number, a VPN, a label, a DNN, a namespace, a DRB, or a QoS flow ID.

According to embodiments, a non-transitory computer-readable storage medium may store one or more programs including instructions which, when executed by a processor of a first entity including a transceiver, cause the first entity to receive, from a second entity for managing a network slice, an initiate message including network slice information. The non-transitory computer-readable storage medium may store one or more programs including instructions which, when executed by the processor, cause the first entity to transmit, to a first node of a first domain, a request message including an identifier for indicating a tag, an ingress identifier, an egress identifier, and information on a policy associated with the tag, based on the network slice information. The non-transitory computer-readable storage medium may store one or more programs including instructions which, when executed by the processor, cause the first entity to receive, from the first node, a response message corresponding to the request message. The ingress identifier may comprise an identifier indicating a second domain for transmitting a packet to the first domain. The egress identifier may comprise an identifier indicating a third domain for receiving the packet from the first domain. The tag may be an identifier for mapping an in-domain resource for the packet and at least one network slice associated with the packet.

Methods according to embodiments described in claims or specifications of the disclosure may be implemented as a form of hardware, software, or a combination of hardware and software.

In a case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to embodiments described in claims or specifications of the disclosure.

Such a program (software module, software) may be stored in a random access memory, a non-volatile memory including a flash memory, a read only memory (ROM), an electrically erasable programmable read only memory (EEPROM), a magnetic disc storage device, a compact disc-ROM (CD-ROM), an optical storage device (digital versatile discs (DVDs) or other formats), or a magnetic cassette. Alternatively, it may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the disclosure through an external port. In addition, a separate storage device on the communication network may also be connected to a device performing an embodiment of the disclosure.

In the above-described specific embodiments of the disclosure, components included in the disclosure are expressed in the singular or plural according to the presented specific embodiment. However, the singular or plural expression is selected appropriately according to a situation presented for convenience of explanation, and the disclosure is not limited to the singular or plural component, and even components expressed in the plural may be configured in the singular, or a component expressed in the singular may be configured in the plural.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first entity, the method comprising:
receiving, from a second entity for managing a network slice, an initiate message including network slice information;
based on the network slice information, transmitting, to a first node of a first domain, a request message including an identifier for indicating a tag, an ingress identifier, an egress identifier, and information on a policy associated with the tag; and
receiving, from the first node, a response message corresponding to the request message,
wherein the ingress identifier comprises an identifier indicating a second domain for transmitting a packet to the first domain,
wherein the egress identifier comprises an identifier indicating a third domain for receiving the packet from the first domain, and
wherein the tag is an identifier for mapping an in-domain resource for the packet and at least one network slice associated with the packet.

2. The method of claim 1,
wherein the second entity comprises a network slice selection function (NSSF) and a network slice management function (NSMF),
wherein the first domain comprises a core network, and
wherein the first node comprises a policy control function (PCF).

3. The method of claim 2,
wherein the second domain comprises a data network, and
wherein the third domain comprises a central unit (CU) of an access network (AN).

4. The method of claim 1, further comprising:
identifying at least one tag based on the information on the network slice included in the initiate message; and
transmitting the request message including an identifier for indicating the at least one tag and information on a policy associated with the at least one tag, to the first node.

5. The method of claim 4,
wherein the response message includes a tag policy identifier,
wherein the method further comprises transmitting a confirmation message including the tag policy identifier to the second entity, and
wherein the tag policy identifier is identified based on mapping information between the tag and a resource, and information on the policy associated with the tag.

6. The method of claim 5, further comprising:
receiving, from the second entity, a key performance indicator (KPI) monitoring message,
wherein the KPI monitoring message includes a network slice identifier, a KPI value, and a switching period.

7. The method of claim 6, further comprising:
identifying whether a change of the at least one tag is needed, based on the KPI monitoring message; and
in response to identifying that the change is needed, identifying whether a reconfiguration of a policy associated with the changed tag is needed.

8. The method of claim 7, further comprising:
in response to identifying that the reconfiguration of the policy is needed, transmitting another request message to the first node; and
in response to identifying that the reconfiguration of the policy is not needed, transmitting an update message to the first node,
wherein the another request message includes an identifier for indicating the changed tag, the ingress identifier, the egress identifier, and information on a policy associated with the changed tag, and
wherein the update message includes an identifier for indicating the at least one tag, the changed identifier, and the egress identifier.

9. The method of claim 8, further comprising:
receiving, from the second entity, a terminate message,
wherein the terminate message includes the tag policy identifier.

10. The method of claim 1,
wherein the ingress identifier includes at least one of a user datagram protocol (UDP) port number, a virtual private network (VPN), a data network name (DNN), a label, a data radio bearer (DRB), or a quality of service (QOS) flow identity (ID), and
wherein the egress identifier includes at least one of a UDP port number, a VPN, a label, a DNN, a namespace, a DRB, or a QoS flow ID.

11. A first entity comprising:
memory, comprising one or more storage media, storing instructions;
a transceiver; and
at least one processor communicatively coupled to the transceiver and the memory,
wherein the instructions, when executed by the at least one processor individually or collectively, cause the first entity to:
receive, from a second entity for managing a network slice, an initiate message including network slice information,
transmit, to a first node of a first domain, a request message including an identifier for indicating a tag, an ingress identifier, an egress identifier, and information on a policy associated with the tag, based on the network slice information, and
receive, from the first node, a response message corresponding to the request message,
wherein the ingress identifier comprises an identifier indicating a second domain for transmitting a packet to the first domain,
wherein the egress identifier comprises an identifier indicating a third domain for receiving the packet from the first domain, and
wherein the tag is an identifier for mapping an in-domain resource for the packet and at least one network slice associated with the packet.

12. The first entity of claim 11,
wherein the second entity comprises a network slice selection function (NSSF) and a network slice management function (NSMF),
wherein the first domain comprises a core network, and
wherein the first node comprises a policy control function (PCF).

13. The first entity of claim 12,
wherein the second domain comprises a data network, and
wherein the third domain comprises a central unit (CU) of an access network (AN).

14. The first entity of claim 11, wherein the instructions, when executed by the at least one processor individually or collectively, further cause the first entity to:
identify at least one tag based on the information on the network slice included in the initiate message; and
transmit the request message including an identifier for indicating the at least one tag and information on a policy associated with the at least one tag, to the first node.

15. The first entity of claim 14,
wherein the response message includes a tag policy identifier,
wherein the instructions, when executed by the at least one processor individually or collectively, further cause the first entity to:
transmit a confirmation message including the tag policy identifier to the second entity, and
wherein the tag policy identifier is identified based on mapping information between the tag and a resource, and information on the policy associated with the tag.

16. The first entity of claim 15,
wherein the instructions, when executed by the at least one processor individually or collectively, further cause the first entity to:
receive, from the second entity, a key performance indicator (KPI) monitoring message, and
wherein the KPI monitoring message includes a network slice identifier, a KPI value, and a switching period.

17. The first entity of claim 16, wherein the instructions, when executed by the at least one processor individually or collectively, further cause the first entity to:
identify whether a change of the at least one tag is needed, based on the KPI monitoring message, and
in response to identifying that the change is needed, identify whether a reconfiguration of a policy associated with the changed tag is needed.

18. The first entity of claim 17,
wherein the instructions, when executed by the at least one processor individually or collectively, further cause the first entity to:
in response to identifying that the reconfiguration of the policy is needed, transmit another request message to the first node, and
in response to identifying that the reconfiguration of the policy is not needed, transmit an update message to the first node,
wherein the another request message includes an identifier for indicating the changed tag, the ingress identifier, the egress identifier, and information on a policy associated with the changed tag, and
wherein the update message includes an identifier for indicating the at least one tag, the changed identifier, and the egress identifier.

19. One or more non-transitory computer-readable storage media storing one or more computer programs including computer-executable instructions that, when executed by at least one processor of a first entity including a transceiver individually or collectively, cause the first entity to perform operations, the operations comprising:
receiving, from a second entity for managing a network slice, an initiate message including network slice information;
based on the network slice information, transmitting, to a first node of a first domain, a request message including an identifier for indicating a tag, an ingress identifier, an egress identifier, and information on a policy associated with the tag; and
receiving, from the first node, a response message corresponding to the request message,
wherein the ingress identifier comprises an identifier indicating a second domain for transmitting a packet to the first domain,
wherein the egress identifier comprises an identifier indicating a third domain for receiving the packet from the first domain, and
wherein the tag is an identifier for mapping an in-domain resource for the packet and at least one network slice associated with the packet.

20. The one or more non-transitory computer-readable storage media of claim 19,
wherein the second entity comprises a network slice selection function (NSSF) and a network slice management function (NSMF),
wherein the first domain comprises a core network, and
wherein the first node comprises a policy control function (PCF).
